(19) United States
(12) Patent Application Publication
(10) Pub. No.: US 2020/0183928 A1
(43) Pub. Date: Jun. 11, 2020

(54) System and Method for Rule-Based Conversational User Interface

(71) Applicant: DeepAssist Inc., Grand Cayman (KY)

(72) Inventor: Xiaoyun WU, Palo Alto, CA (US)

(21) Appl. No.: 16/558,104

(22) Filed: Aug. 31, 2019

(30) Foreign Application Priority Data
Dec. 11, 2018 (CN) 201811511713.9
Dec. 11, 2018 (CN) 201811511714.3

(51) Int. Cl. G06F 16/2452; G06N 20/00; G06N 5/04; G06F 17/27

(52) U.S. Cl. CPC G06F 16/24522; G06N 20/00; H04L 67/10; G06F 17/2765; G06N 5/046

(57) ABSTRACT

A system for rule-based conversational user interface is configured to receive a user request from a user device, to determine a frame related to the user request, and to select a set of rules from a rule database associated with the frame based on the user request. In response to the set of rules having more than one rule, one or more prompt questions are transmitted to the user device. In response to receiving one or more user answers to the one or more prompt questions, one or more rules from the set of rules are eliminated based on the one or more answers. The process continues until the set of rules include one remaining rule. A response included in the one remaining rule is then transmitted to the user device as fulfillment to the user request.

### CROSS REFERENCE TO RELATED APPLICATION

The present application claims the benefit of priority under the Paris Convention to Chinese Patent Application No. 201811511713.9, entitled “Method and System for Generating Interactive Applications,” filed Dec. 11, 2018, and Chinese Patent Application No. 201811511714.3, entitled “Method and System for Service Information Interaction,” filed Dec. 11, 2018, each of which is incorporated herein by reference in its entirety.

### TECHNICAL FIELD

The disclosed implementations relate generally to information technologies, and more specifically to a rule-based response system and method for structuring and serving information using a conversational user interface.

### BACKGROUND

A conversational user interface (UI) allows a user to interact with a computing system or device such as a smart phone using verbal or textual commands to obtain service or information. Conversational UIs have become popular tools for content or service providers to distribute content or provide customer service, as well as for individual users to accomplish certain tasks such as setting up reminders, turning off lights, making dinner reservations, etc. The most alluring feature of conversational interfaces is the natural and frictionless experience a user can obtain when interacting with a computing system.

In general, conversational UIs use a voice assistant that communicates with users orally, and/or chat bots that communicate with users through text. These conversational UIs combine voice detection technologies, artificial intelligence reasoning, and contextual awareness to carry on conversation and to acquire more information from the user until the user's request is fulfilled and/or the requested task accomplished.

Conventionally, a conversational UI is typically based on a decision tree that starts with a single node representing, for example, a multiple choice question, and branches into possible answers to the multiple choice question. Each of the possible answers may then lead to additional nodes or questions, which may branch off into other possible answers, and so forth. Thus, such a conversational UI navigates a conversation flow by moving from node to node asking one question after another until no more questions are left to be asked. This process makes designing the decision tree to map out the steps a difficult task, achievable only by highly-trained professionals. For example, depending on how many questions that need to be answered in order to fulfill a request and the possible answers one can give for each of those questions, there may be millions of different ways a conversation could be carried out. Furthermore, the more questions needed to be asked to fulfill a request, the longer the user will have to be engaged in the conversation, or the slower the request can be fulfill. As a result, the user's experience with the UI is negatively impacted.

### SUMMARY

In some embodiments, system and method for structuring and serving information in an efficient manner using a rule-based conversational UI are provided. In some embodiments, semantics of task-oriented conversations are organized into a knowledge database using high level abstraction. The knowledge database includes a collection of individual frames, each frame corresponding to a semantic framework for a particular topic or category of tasks or information (e.g., providing medical diagnostics, setting reminders, making reservations, purchasing event tickets, etc.). The knowledge database also includes rules. Each rule is a logic basis (e.g., a logical equation) that includes one or more conditions and a response to be provided to the user when the one or more conditions are satisfied. The frames and rules allow information or service providers to build rule-based conversation UIs for complex real world problems without requiring a high level of technical skills.

In some embodiments, a declarative approach is used to construct a dialogue in a conversation using structured information and a methodology that does not require specific mapped steps. This approach allows the development process to be streamlined by reducing the complexity of system maintenance. Additionally, such an approach allows a conversational UI system to be adaptable and portable among multiple domains and applications.

Using the declarative approach, a domain expert (e.g., conversational UI developer for an information or service provider) can build a knowledge database without detailed understanding of the techniques embedded in the conversational UI system, such as machine learning models, algorithms, statistics, etc. The domain expert, such as a retail shop manager, or a pre-diagnosis medical receptionist, can simply input rules that lead a user to the correct system response. For example, in a retail application, the response could be providing a user with a link to purchase a requested merchandise or a link to a check out webpage that has the requested merchandise automatically loaded in a on-line shopping cart. In another example, for a pre-diagnosis application, the response could be a recommendation to call or seek emergency medical services with the relevant phone number or address. Each of the rules includes a set of conditions with specific attribute values and a response when the conditions are satisfied based on answers in the dialogue. Based on the rules, a frame storing the attributes included in the rules is created. A domain expert can select training sentences for the particular domain (e.g., topic) to be used to train the machine learning model(s) to correctly match user requests to a relevant set of rules associated with a relevant frame. With the knowledge database components defined, a rule-based conversational UI system can be used to interact (e.g., orally, or via written text) with the users on a specific topic or in a specific domain, and service the user by fulfilling the user's requests.

Thus methods, systems, and interfaces are provided with regards to a rule-based conversational UI system, and development and performance thereof.

In accordance with some implementations, a method is performed by one or more computer systems that are coupled to a network and include one or more processors. The method includes receiving, by a processor of the one or more processors, a user request from a user device in the network. The method also includes determining a frame related to the user request. The frame includes a plurality of attribute. Each respective attribute of the plurality of attributes have a respective name, a respective type, and a respective prompt question for inquiring about a value for the respective attribute. The method further includes selecting a set of rules from a rule database associated with the frame based on the request. Each rule of the set of rules includes one or more conditions and a corresponding response, and each condition includes an attribute related to the user request and a value or range of values for the attribute. In response to the set of rules including more than one rule the method includes selecting one or more attributes that are included in at least one rule of the set of rules; transmitting, to the user device, one or more prompt questions associated with the one or more attributes; receiving one or more answers to the one or more prompt questions from the user device, the one or more answers including one or more values for the one or more attributes; and eliminating one or more rules from the set of rules based on the one or more answers. In response to all other rules except one remaining rule having been eliminated from the set of rules, the method includes transmitting the response included in the one remaining rule to the user device.

In accordance with some implementations, a method to generate knowledge databases corresponding to a plurality of expert system coupled to a network and associated with a plurality of distinct knowledge domains is performed by one or more computer systems coupled to a network. The one or more computer systems include one or more processors. The method includes, for each respective knowledge domain of the plurality of distinct knowledge domains, launching, by a processor of the one or more processors, at least one respective user interface to receive respective inputs from a respective expert system associated with the respective knowledge domain. The at least one respective user interface includes respective attribute input fields and respective rule input fields. The respective inputs include a plurality of attributes that are received via the respective attribute input fields. Each attribute of the plurality of attributes has a name, a type, and a prompt question for inquiring about a value for the each attribute. The respective inputs also include a plurality of rules received via the respective rule input fields. Each rule of the plurality of rules includes one or more conditions and a corresponding response. Each condition of the one or more conditions includes one or more attributes and a value or range of values for each of the one or more attributes. The method further includes forming a respective frame corresponding to the respective knowledge domain using the plurality of attributes and associating the plurality of rules with the respective frame.

### BRIEF DESCRIPTION OF THE DRAWINGS

For a better understanding of the aforementioned implementations of the invention as well as additional implementations, reference should be made to the Description of Implementations below, in conjunction with the following drawings in which like reference numerals refer to corresponding parts throughout the figures.

FIG. 1A is a diagram illustrating an environment in which a rule-based conversational UI system according to some implementations operates.

FIG. 1B is a block diagram of a computing platform for a rule-based conversational UI system according to some implementations.

FIG. 1C is a block diagram of a computing system implementing a rule-based conversational UI system according to some implementations.

FIG. 1D is a block diagram of a user device according to some implementations.

FIG. 1E is a block diagram of an expert system according to some implementations

FIG. 2 is a block diagram of a rule-based conversational UI system according to some implementations.

FIG. 3A is a schematic representation of a frame according to some implementations.

FIG. 3B is an example of a few attributes in a frame according to some implementations.

FIG. 4A is an example of a rule according to some implementations.

FIG. 4B is an example of a rule according to some implementations.

FIG. 4C illustrates the relationship between a frame and a set of rules according to some implementations.

FIG. 5A illustrates a flow chart of a method of fulfilling a user request by a conversational UI system according to some implementations.

FIGS. 5B-5C illustrate dialogues in an example of a conversation session between a user and a conversational UI system (or dialog system) according to some implementations.

FIGS. 5D-5E illustrate an example of using the conversational UI system to fulfill a user request based on user inputs according to some implementations.

FIG. 6 illustrates an example of display of the conversational UI system according to some implementations.

FIG. 7A is a schematic representation of an expert user input interface according to some implementations.

FIG. 7B illustrates an example of an expert user input interface according to some implementations.

FIGS. 8A-8C is a flow chart illustrating a method performed by a conversational UI system according to some implementations.

FIG. 9 is a flow chart illustrating a method of generating knowledge databases for a conversational UI system according to some implementations.

Like reference numerals refer to corresponding parts throughout the drawings.

Reference will now be made in detail to implementations, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details.

### DESCRIPTION OF IMPLEMENTATIONS

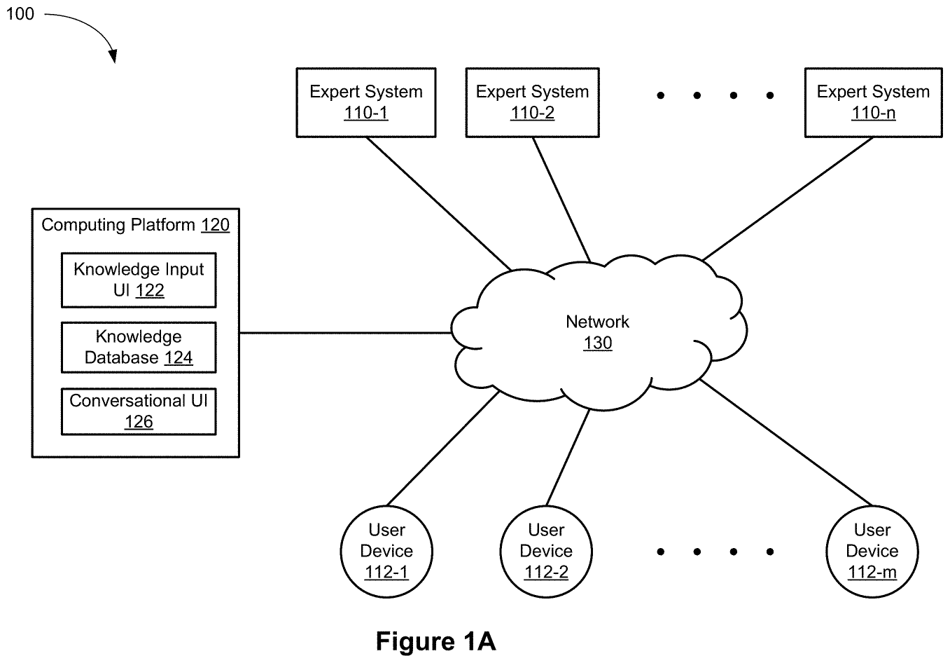

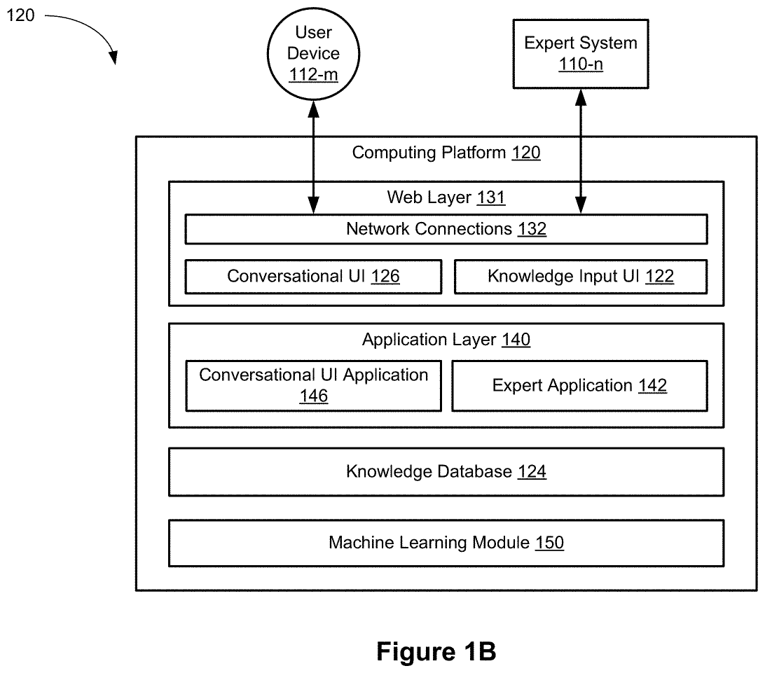

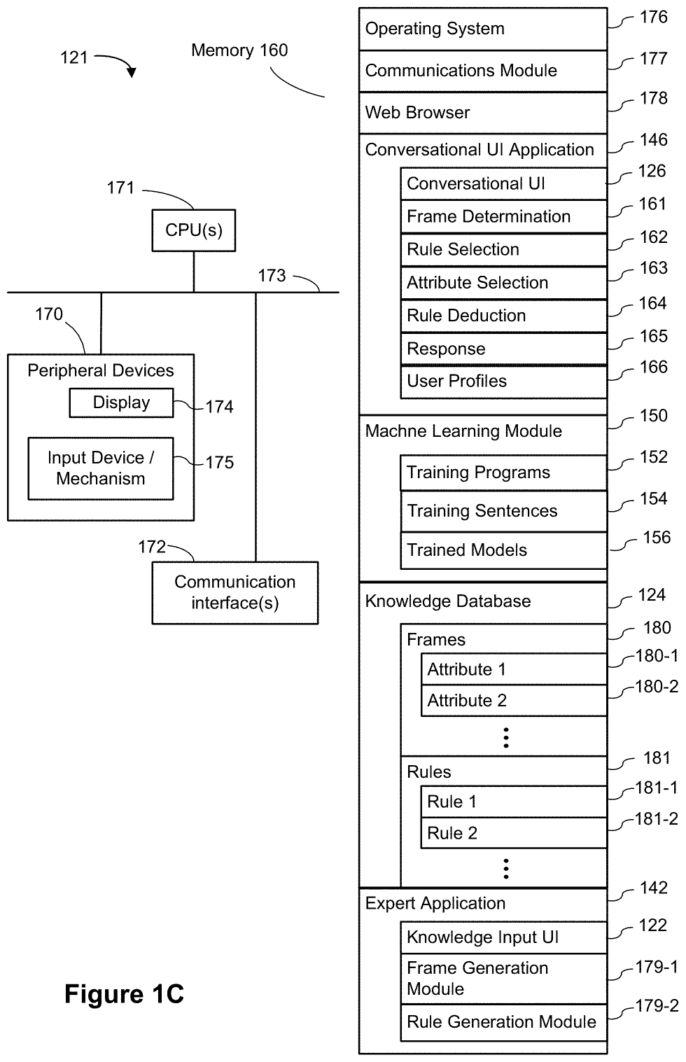

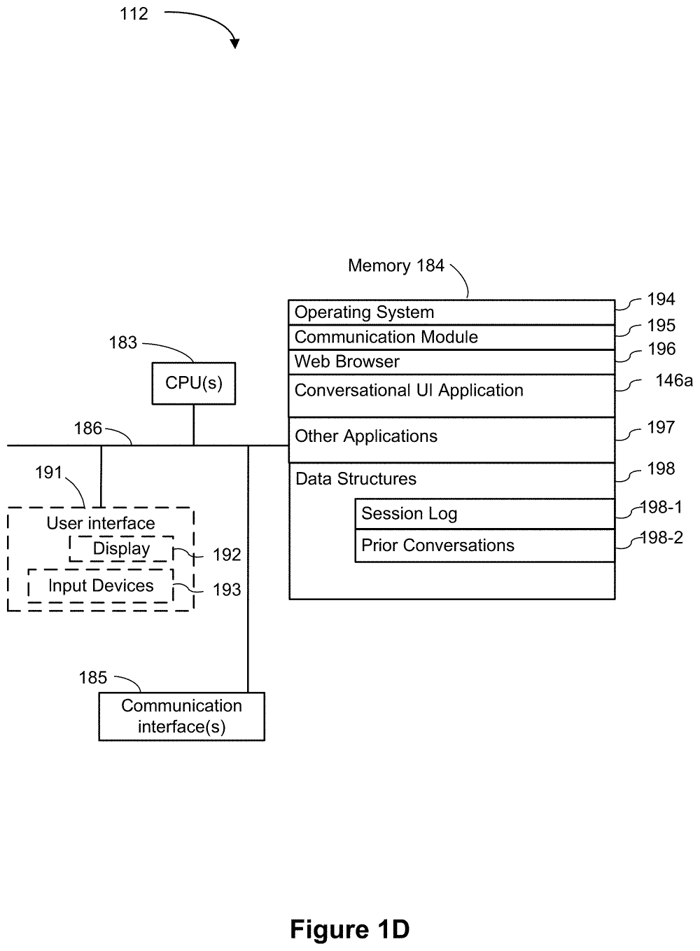

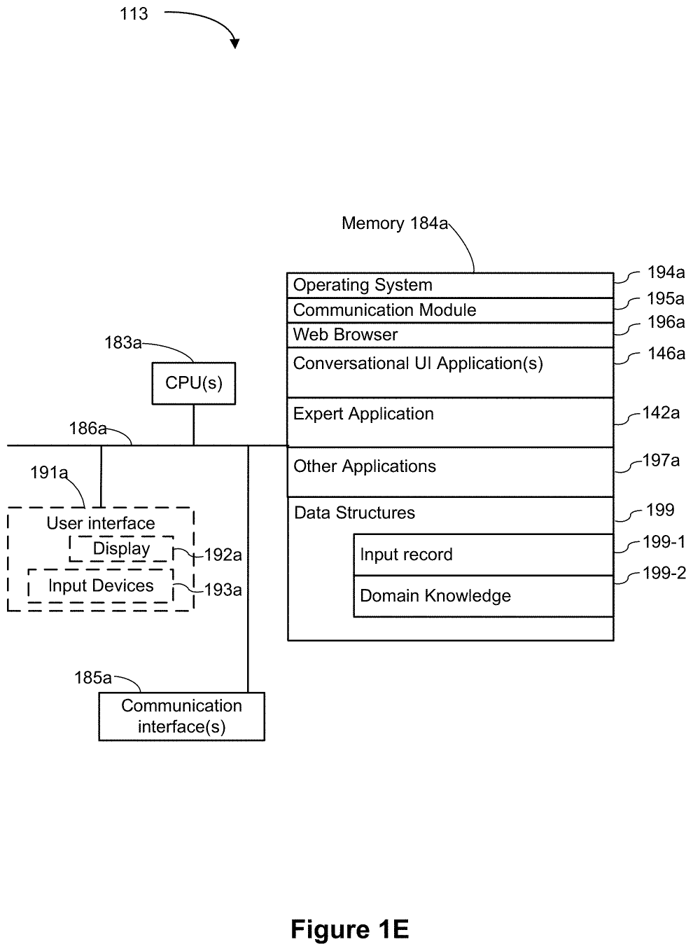

FIG. 1A is a diagram illustrating an environment 100 in which a rule-based conversational UI system 200 according to some implementations operates. As shown, environment 100 includes one or more expert systems 110, utilized by one or more expert users (e.g., content or service providers); one or more user devices 112, utilized by one or more users; and a computing platform 120 including a rule-based conversational UI system 200. Each expert system 110 and each user device 112 is connected to computing platform 120 via one or more communication networks 130, such as the Internet, other wide area networks, local area networks, metropolitan area networks, etc. The computing platform includes knowledge input UI 122, which allows expert users to develop and design conversational UI applications via expert systems 110; knowledge database 124, which stores information input by expert users and in some cases, also stores information acquired from user devices 112; and conversation UI 126, which allows users to interact with conversational UI systems via user devices 112.

FIG. 1B is a block diagram of computing platform 120 according to some implementations. Computing platform 120 includes a web layer 131, which includes one or more network connections 132, conversational UI 126, and knowledge input UI 122. Computing platform 120 also includes an application layer 140 that includes user application(s) 146 (e.g., conversational UI application 146) and an expert application 142. As shown, expert systems 110 and user devices 112 can access the application layer 140 via network connections 132 and knowledge input UI 122 and conversational UI 126, respectively. When a user device 112 connects to computing platform 120, the user device 112 can interact with the user application(s) 146 via conversational UI 126, and when an expert system 110 connects to computing platform 120, the expert system 110 can interact with the expert application 142 via knowledge input UI 122. The computing platform 120 further includes a knowledge database 124 and a machine learning module 150.

In some implementations, computing platform 120 is implemented using one or more servers and/or other computing devices, such as desktop computers, laptop computers, tablet computers, and other computing devices with one or more processors capable of running or hosting the user application(s) 146 (e.g., conversational UI application 146) and/or the expert application 142. Knowledge database 124 may be stored in one or more memory and/or storage devices associated with the one or more servers and/or other computing devices, or in a network storage accessible by the one or more servers and/or other computing devices, including capabilities for database organization (e.g., organizing information in the knowledge database 124 into frames) as well as capabilities for adding new information or removing existing information in existing databases. FIG. 1C illustrates a block diagram of a server or computing device 121 used to provide computing platform 120.

As shown in FIG. 1C, computing device 121 includes memory 160 and one or more processing units/cores (CPUs) 171 for executing modules, programs, and/or instructions loaded in the memory 160 and thereby performing processing operations. Computing device 121 further includes one or more network or other communications interfaces 172, and peripheral devices 170, which may include a display and one or more input devices/mechanism 175 (e.g., a keyboard, a keypad, a touch screen, a mouse, a touchpad, etc.), coupled to the CPU 171 via one or more communication buses 173. The communication buses 173 may include circuitry that interconnects and controls communications between system components. In some implementations, the display 174 and input devices/mechanism 175 comprise a touch screen display (also called a touch sensitive display). In some implementations, the display is an integrated part of the computing device. In some implementations, the display is a separate display device. In some implementations, the input device/mechanism 175 may include a microphone.

In some implementations, the memory 160 includes high-speed random-access memory, such as DRAM, SRAM, DDR RAM or other random-access solid-state memory devices. In some implementations, the memory 160 includes non-volatile memory, such as one or more magnetic disk storage devices, optical disk storage devices, flash memory devices, or other non-volatile solid-state storage devices. In some implementations, the memory 160 includes one or more storage devices remotely located from the CPUs 171. The memory 160, or alternately the non-volatile memory device(s) within the memory 160, comprises a non-transitory computer readable storage medium. In some implementations, the memory 160, or the computer readable storage medium of the memory 160, stores the following programs, modules, and data structures, or a subset thereof:
an operating system 176, which includes procedures for handling various basic system services and for performing hardware dependent tasks;
a communication module 177, which includes procedures for connecting the computing device to other computers and devices via the one or more communication network interfaces 172 (e.g., network connections 132) (wired or wireless) and one or more communication networks, such as the Internet, other wide area networks, local area networks, metropolitan area networks, and so on;
a web browser 178, which includes procedures to enable a user of computing system 121 (e.g., computing device 121) to communicate with remote computers or devices over a network; and
conversational UI application 146, which include procedures to provide conversational UI's 126 to users to receive user requests, and which include a frame determination module 161 configured to process user requests to determine an appropriate frame for each request of the user requests, a rule selection module 162 configured to select a set of rules for the frame, an attribute selection module 163 configured to select an attribute in the set of rules and to present a question to solicit a user input for the value of the selected attribute, a rule deduction module 164 configured to deduct one or more rules from the set of rules based on the user input, a response module 165 configured to present a response to the request based on the last remaining rule in the set of rules, and a user profiles module 166 configured to keep track of user profiles and interactions with the conversational UI application 146. The conversational UI application 146 utilizes information stored in knowledge database 124 to carry out conversations with users so as to fulfill user requests. In some implementations, the conversational UI application 146 is accessible via a standalone application (e.g., a desktop application or smart phone application) on user devices 112. In some implementations, the conversational UI application 146 is accessible via a web browser (e.g., as a web application) on user devices 112;
a machine learning module 150, which includes machine learning or training programs 152 configured to train one or more machine learning models 152 using a collection of training sentences 154;
a knowledge database 124 that stores organized information, such as frames 182, attributes (e.g., attributes 180-1 and 180-2) and rules (e.g., rules 181-1 and 181-2).
an expert application 142 includes a knowledge input UI 122 for expert users to input domain expert information for the knowledge database 124, a frame generation module 179 configured to structure some of the domain expert information into frames, and a rule generation module configured to formulate some of the domain expert information into rules. In some implementations, the expert application 142 is accessible via a standalone application (e.g., a desktop application or smart phone application) on expert systems 110. In some implementations, the expert application 142 is accessible via a web browser (e.g., as a web application) on expert systems 110.

Each of the above identified executable modules, applications, or set of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 160 stores a subset of the modules and data structures identified above. In some implementations, the memory 160 stores additional modules or data structures not described above.

Although FIG. 1C shows a computing device corresponding to computing platform 120, FIG. 1C is intended more as a functional description of the various features that may be present rather than as a structural schematic of the implementations described herein. In practice, and as recognized by those of ordinary skill in the art, items shown separately could be combined and some items could be separated. In addition, some of the programs, functions, procedures, or data shown above with respect to a computing platform 120 may be stored or executed on one or more computing systems or devices. In some implementations, the functionality and/or data may be allocated between a computing device and one or more servers of computing platform 120. Furthermore, one of skill in the art recognizes that FIG. 1C need not represent a single physical device. In some implementations, the server functionality is allocated across multiple physical systems or devices that comprise a server system. As used herein, references to a “server” or “data visualization server” include various groups, collections, or arrays of servers that provide the described functionality, and the physical servers need not be physically collocated (e.g., the individual physical devices could be spread throughout the United States or throughout the world).

FIG. 1D is a block diagram illustrating a computing device 112, corresponding to any of user devices 112-1, 112-2, . . . , 112-m, that can interact with conversational UI 126. Computing device 112 can be a desktop computer, laptop computer, tablet computer, a smart phone, or any other computing device with a memory 184 and a processor (e.g., CPU 183) capable of accessing information on the Internet via web browser 196 or running a conversational UI application by executing a conversational UI application program 146a loaded in memory 184. A computing device 112 (e.g., user device 112) typically includes one or more processing units/cores (CPUs) 183 for executing modules, programs, and/or instructions stored in a memory 184 and thereby performing processing operations, one or more network or other communications interfaces 185, memory 184, and one or more communication buses 186 for interconnecting these components. The communication buses 186 may include circuitry that interconnects and controls communications between system components. A computing device 190 includes a user interface 191 comprising a display 192 and one or more input devices or mechanisms 193. In some implementations, the input device/mechanism 193 includes a keyboard; in some implementations, the input device/mechanism includes a “soft” keyboard, which is displayed as needed on the display 192, enabling a user to “press keys” that appear on the display 192. In some implementations, the display 192 and input device/mechanism 193 comprise a touch screen display (also called a touch sensitive display). In some implementations, the display 192 is an integrated part of the computing device 190. In some implementations, the display is a separate display device. In some implementations, the input device/mechanism 193 may include a microphone.

In some implementations, the memory 184 includes high-speed random-access memory, such as DRAM, SRAM, DDR RAM or other random-access solid-state memory devices. In some implementations, the memory 184 includes non-volatile memory, such as one or more magnetic disk storage devices, optical disk storage devices, flash memory devices, or other non-volatile solid-state storage devices. In some implementations, the memory 184 includes one or more storage devices remotely located from the CPUs 183. The memory 184, or alternately the non-volatile memory device(s) within the memory 184, comprises a non-transitory computer readable storage medium. In some implementations, the memory 184, or the computer readable storage medium of the memory 184, stores the following programs, modules, and data structures, or a subset thereof:
an operating system 194, which includes procedures for handling various basic system services and for performing hardware dependent tasks;
a communication module 195, which is used for connecting the user device 112 (e.g., computing device 112) to other computers and devices via the one or more communication network interfaces 185 (wired or wireless) and one or more communication networks, such as the Internet, other wide area networks, local area networks, metropolitan area networks, and so on;
a web browser 196 (or other client application), which enables a user to communicate over a network with remote computers or devices;
a conversational UI application 146a, which provides a user interface 191 for a user to interact with the conversation UI computing system or server (e.g., computing platform 120) by, for example, making requests and/or providing user inputs;
other applications 197, either native or user-installed; and
various data structures 198 used by the web browser 196, the conversational UI application 146a, and other applications 197, including, for example, a session log keeping track of a current conversation, and records of prior conversations with the conversational UI application 146.

FIG. 1E is a block diagram illustrating a computing device 113, corresponding to any of expert systems 110-1, 110-2, . . . , 110-n, that can interact with the expert application 142 via the knowledge input UI 122. In some implementations, the computing device 190 has a graphical user interface 191 for a conversational UI application(s) 146a and a expert application 142a. Computing devices 190 include desktop computers, laptop computers, tablet computers, and other computing devices with a display 191a, memory 184a, and a processor 183a configured to enable domain expert interactions with the conversational UI application(s) 146 and expert application 142 running on computing system 121 (e.g., computing device 121) via conversational UI application(s) 146a and expert application 142a, or via a web browser 196a. A computing device 113 typically includes one or more processing units/cores (CPUs) 183 for executing modules, programs, and/or instructions stored in a memory 184 and thereby performing processing operations, one or more network or other communications interfaces 185a, memory 184a, and one or more communication buses 186a for interconnecting these components. The communication buses 186a may include circuitry that interconnects and controls communications between system components. A computing device 190 includes a user interface 191a comprising a display 192a and one or more input devices or mechanisms 193a. In some implementations, the input device/mechanism 193a includes a keyboard; in some implementations, the input device/mechanism includes a “soft” keyboard, which is displayed as needed on the display 192a, enabling a user to “press keys” that appear on the display 192a. In some implementations, the display 192a and input device/mechanism 193a comprise a touch screen display (also called a touch sensitive display). In some implementations, the display 192a is an integrated part of the computing device 190a. In some implementations, the display is a separate display device. In some implementations, the input device/mechanism 193a may include a microphone.

In some implementations, the memory 184a includes high-speed random-access memory, such as DRAM, SRAM, DDR RAM or other random-access solid-state memory devices. In some implementations, the memory 184a further includes non-volatile memory, such as one or more magnetic disk storage devices, optical disk storage devices, flash memory devices, or other non-volatile solid-state storage devices. In some implementations, the memory 184a includes one or more storage devices remotely located from the CPUs 183. The memory 184a, or alternately the non-volatile memory device(s) within the memory 184a, comprises a non-transitory computer readable storage medium. In some implementations, the memory 184a, or the computer readable storage medium of the memory 184a, stores the following programs, modules, and data structures, or a subset thereof:
an operating system 194a, which includes procedures for handling various basic system services and for performing hardware dependent tasks;
a communication module 195a, which includes procedures for connecting the computing device 113 to other computers and devices via the one or more communication network interfaces 185 (wired or wireless) and one or more communication networks, such as the Internet, other wide area networks, local area networks, metropolitan area networks, and so on;
a web browser 196a (or other client application), which enables a user to communicate over a network with remote computers or devices;
a conversational UI application 146a, which provides a user interface 191a for a user to interact with the computing platform 120 by, for example, making requests and/or providing user inputs;
an expert application 142a, which provides a user interface 191a for a user to interact with the computing platform 120 by, for example, entering information for the knowledge database;
other applications 197a, either native or user-installed; and
various data structures 199 used by the web browser 196a, the conversational UI application 146a, the expert application 142a and other applications 197a, including, for example, input record 199-1, and domain knowledge data 199-2.

Each of the above identified executable modules, applications, or set of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 184 stores a subset of the modules and data structures identified above. In some implementations, the memory 184 stores additional modules or data structures not described above.

Although FIG. 1D or 1E shows a computing device 112 or a computing system 112, each of FIGS. 1D and 1E is intended more as functional description of the various features that may be present rather than as a structural schematic of the implementations described herein. In practice, and as recognized by those of ordinary skill in the art, items shown separately could be combined and some items could be separated.

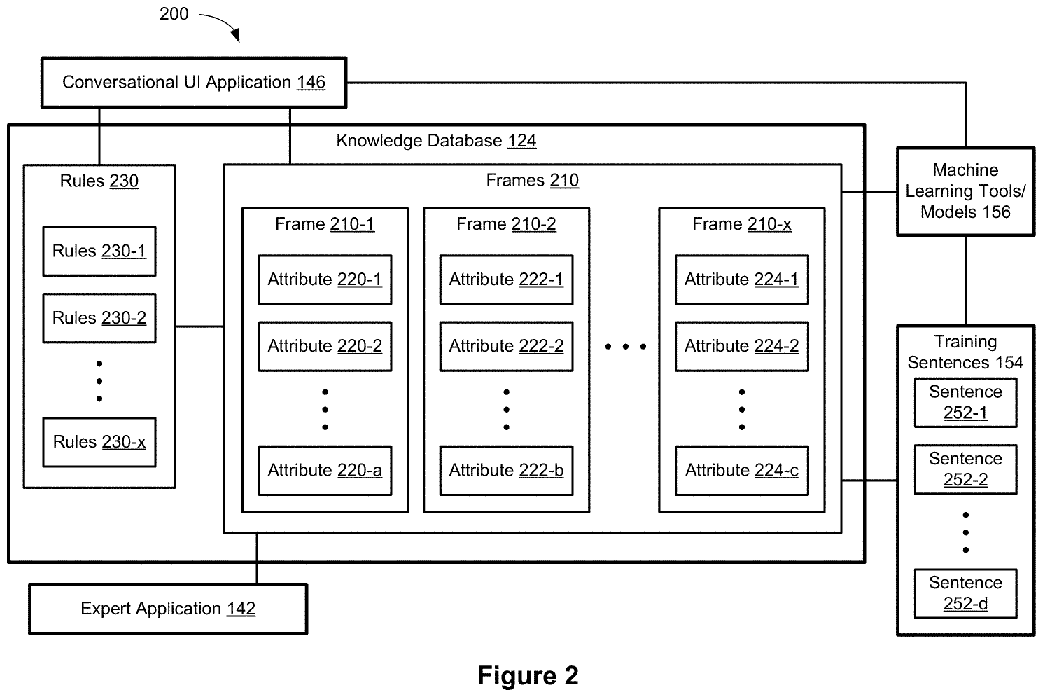

FIG. 2 is a block diagram of a rule-based conversational UI system 200 according to some implementations. As shown, rule-based conversational UI system 200 includes a knowledge database 124, machine learning module 156, training sentences 154, a conversational UI application 146, and an expert application 142.

The knowledge database 124 includes frames 210, such as frames 210-1, 210-2, . . . , 210-x. Each frame corresponds to a domain or a topic (e.g., medical diagnosis, event tickets, reservations, etc.). Each frame 210 includes a plurality of attributes that relates to the frame. For example, frame 210-1 includes attributes 220-1, 220-2, . . . , 220-a and frame 210-2 includes attributes 222-1, 222-2, . . . , 222-b. While each attribute in the frames 210 is distinct from one another (e.g., attribute 220-1 may be related to medical diagnosis and may have the attribute name “cough” attribute 222-1 may be related to scheduling and may have the attribute name “time”), some attributes may have a similar or same name while being associated with different frames. For example, attribute 222-1, related to scheduling, may have the attribute name “date” and attribute 224-1 may be related to purchasing event tickets and may also have the attribute name “date”.

The knowledge database 124 also includes rules 230 organized in a plurality of rule databases, such as rule databases 230-1, 230-2, . . . , 230-x, associated, respectively, with the frames 210-1, 210-2, . . . , 210-x. The rules 230 and frames 210 are related to one another via the attributes. The frames serve as the basis for the rules in respective rule databases. For example, a particular frame defines the attributes in a particular domain or related to a particular topic, to which a user request is directed. A rule in the rule database associated with the particular frame provides conditions that need to be met in order to execute a response to the user request. Thus, rules and frames are used in conjunction with one another when executing a conversational UI application 146. The frames 210 and rules 230 are provided (e.g., input) by domain experts via knowledge input UI 122 and expert application 142 and are used by conversational UI application(s) 146 to fulfill users' requests.

The frames 210 and the structured data (e.g., attributes) in the frames set the foundation of the conversational UI system and are used to keep conversational flows efficient. For a problem in a particular domain (e.g., on a particular topic), information related to the problem and their properties are defined in one frame. For example, frame 210-1 may correspond to a medical assistant domain and the information (e.g., symptoms) related to certain diagnosis is defined as attributes (e.g., attributes 220-1, 220-2, . . . , 220-a) in the frame 210-1. The rules (e.g., rules in rule database 230-1) related to the frame would include potential solutions (e.g., responses) to the user's problem or request. The rules are defined using attributes. In order to meet a condition in a particular rule, the value of a particular attribute needs to be within certain range or have a certain value. The conversational UI system analyzes the user's request to determine the user's intention (e.g., context of the user request) and retrieve the relevant rules. Based on the attributes mentioned in the rule conditions, the conversational UI system then acquires the value of that attribute from the user and compares the value provided by the user with the criteria of condition to determine if the condition is met.

In some implementations, conversational UI application 146 also includes the technical features such as Automatic Speech Recognition (ASR), Natural Language Understanding (NLU), etc. These features are used to obtain and interpret user input in order to determine user intent or to extract information required to complete the user request. These features are integrated into the conversational UI system such that they are automatically generated as a product of defining a conversation using the conversational UI system. These technical components are hidden from an expert user (e.g., a conversational UI developer) so that no additional work is needed to integrate these components into conversational UI application 146. These technical components include machine learning models and training sentences that are used to map a user's input into information that can be processed and used by a conversational UI system in fulfilling the user's request.

A plurality of training sentences 154 are used to train machine learning models 156. Once trained, the machine learning models 156 are configured to allow the ASR/NLU components to correlate a user request with a relevant frame and to extract information from a user's input (e.g., answers) in order to determine a value associated with an attribute.

In order to determine a relevant frame based on a user's initial request. In some implementations, such as ones where the user input is a voice command, the machine learning models 156 are trained to receive the user's audio input (e.g., sound waves) and translate the user's input into plain text. In some implementations, the machine learning models 156 are also trained to match the translated user input to one or more training sentences that have been defined for each frame 210 in the knowledge database 124. In order to perform the comparison (and match), the training sentences include trigger phrases. Each of the trigger phrases are associated to a specific frame 210 via a frame identifier. In some implementations, the trigger phrases are labeled with a frame identifier by a human developer. Some examples of training sentences are:
(“My stomach hurts”, Medical Assistant)
(“I need new shoes”, Shopping Assistant)
(“I need a vacation”, Travel Assistant)
(“Tell me a joke”, Entertainment Assistant)

In the first example, “My stomach hurts” is the trigger phrase and “Medical Assistant” is the frame identifier. In some implementations, as shown, the frame identifier includes text, such as a frame name or a string of characters (e.g., “Med”). Alternatively, the frame identifier may include numerical values or may be a numerical identifier (e.g., “MED_1”, “MED1”, or “210-1”).

The translated user input is compared to the list of trigger phrases. If an exact match is found, then that particular frame tagged with that training phrase is selected as the context for the conversation. This match is the fastest method. However, the user input may not be an exact match to one of the trigger phrases. In such cases, the machine learning models 156 may use a text similarity model to classify the translated user input as being associated with a particular trigger phrase. In some implementations, three layers of training are performed for the machine learning model:
(1) using general language data of similar phrases and expressions (e.g., using a dictionary, thesaurus or other available documents);
(2) using information on the internet that may contain similar phrases and expressions (e.g., using blogs social media posts, tweets, etc); and
(3) using phrases and expressions that are classified, by human developers, as being similar to one another. These training sentence are designed more specific for the frames that are known to the developers. An example of a group is: (“My stomach hurts”, “My tummy feels awful”, “I have stomach ache”, “My belly feels bad” . . . .)

A trained text similarity model, analyzes the translated user input to determine a similarity between the translated user input and any trigger phrases in the training sentences 250. The trained text similarity model assigns a similarity value to each comparison. For example, a similarity value close to 0 corresponds to little or no similarity between the translated user input and the particular trigger phrase and a similarity value close to 1 indicates that the translated user input is very similar to the particular trigger phrase. For a translated user input at the start of the conversation (e.g., an initial user request), no context is provided and the translated user input is compared to all possible trigger phrases. Since there can be a large number of trigger phrases, two layers of machine learning models may be used: a coarse model (e.g., keyword model or shallow neural network model) and a refined model (e.g., deep neural network model or Bidirectional Encoder Representations from Transformers similarity based neural matching model). Both models are trained by the same approach as described herein. These models include two mechanisms, an encoder that reads the text input and a decoder that produces an output prediction for the task. The coarse model has fast response time with acceptable accuracy. Compared to the coarse model, the refined model, which may be implemented with deeper learning neural network, has improved accuracy but a slower response time due to the heavy computation involved. In some implementations, the coarse model (e.g., a small model framework) is distinguished from the refined model by a relatively lightweight shallow convolutional neural network (CNN). CNN is a class of deep neural networks of neurons at input and an output layer, as well as multiple hidden layers. Each neuron in a neural network computes an output value by applying some function to the input values coming from the receptive field in the previous layer. The function that is applied to the input values is specified by a vector of weights and a bias (typically real numbers). Learning in a neural network progresses by making incremental adjustments to the biases and weights. A lightweight shallow model can be used in the coarse model, then supplemented with a deep large model with regards to specific input features so that the combined predication model is flexible yet includes enough detail to be accurate.

In some implementations, the coarse model is first applied to the translated user text in order to compare the translated user text to a large number of trigger phrases and select a group of most relevant phrases. From the selected group of relevant phrases, a group of most relevant (e.g., highest scores) trigger phrases are selected. The selected group of most relevant trigger phrase is reduced from a large pool (e.g., 100,000) to a small pool (e.g., 50) of trigger phrases. The small pool of trigger phrases will mostly likely contain the correct trigger phrase that corresponds most closely to the translated user input. The refined model compares the translated user input with the trigger phrases in the small pool and selects the most relevant trigger phrase (e.g., the trigger phrase with the highest score). The frame identifier tag associated with the selected trigger phrase is returned to indicate that the user's input corresponds to the particular frame. The coarse refined models are used to achieve a balance of accuracy and time efficiency.

There are many possible steps taken within the refined model's analysis in determining similarity values. The NLU processing pipeline is one such method to analyze the translated user input. The method may include:
1. sentence segmentation;
2. breaking a sentence down into words;
3. classifying each word into nouns, verbs, etc. Each word is fed into a pre-trained part-of-speech classification model. There are many available part-of-speech models that have been trained using many (e.g., millions) sentences with each word's part of speech tagged;
3. identifying basic word form and filter out filler words;
4. building a parsing tree using dependency parsing. There are available dependency parsers that use a machine learning approach; and
5. recognizing named entities to label nouns with real-world concepts that they represent.

Using the methods described herein, machine learning models 156 may extract keywords from sentences that correspond to attributes stored in a frame database 209 in order to determine a frame that is relevant to the user's request. For example, sentence 252-1 states “I have a headache” and corresponds to a frame corresponding to medical diagnosis. The machine learning models 156 may extract the word “headache” and match it to an attribute that is stored in a frame corresponding to medical diagnosis. The machine learning models use such training sentences to learn which keywords are relevant and can be used for determining relevant frames. Using the machine learning models 156, a conversational UI application 146 is capable of matching a user's request to a relevant frame.

Additionally, during the conversation, the conversational UI system may ask the user questions in order to gather additional information and check if the conditions in the rule(s) are met. The trained machine learning models are also used to interpret the user's input to extract a value associated with an attribute. The training sentences are a set of data to pair user utterance into specific value. Once the machine learning model(s) are trained, using the training sentences, the machine learning model(s) are expected to be able to extract information from user input into relevant values and determine if conditions within a rule are met or if the rule(s) should be eliminated.

When using the machine learning model(s) 156 to extract information regarding values that correspond to an attribute, since the context of the conversation is known and the relevant frame has been identified, the machine learning models 156 used here are trained using training sentence have the format of (Prompt question, answer, polarity value). In some implementations, the polarity value is a Boolean value that indicates that the user's response corresponds to a simple “yes” or “no”. In some implementations, the polarity value can be, for example, a 0 to indicate negative answer, a 1 to indicate a positive answer, and a 2 for uncertain answers. Some examples of such training sentences are:
(“Do you have a fever?”, “I am burning”, 1)
(“Do you have a fever?”, “I don't know but I feel chilly”, 2)

In the example, for the given prompt question, a “yes” or “no” answer is expected. “I am burning” means yes and it has to be interpreted after that training sentence is taken into the model. An answer such as “I don't know . . . ” is interpreted as “No”.

For the answer that requires an attribute value, a training sentence has the format of (Prompt question, answer, relevance value). For example, a relevance value of 0 indicates that the answer is not relevant, a relevance value of 1 indicates a relevant answer, and a relevance value of 2 indicates a uncertain answer. Some examples of such training sentences are:
(“What is your temperature?”, “about 100 degrees”, 1)
(“What is your temperature?”, “I have no idea”, 2)

If the user answer is relevant to the prompt question, NLU techniques are used to break the answer and extract the values into the attribute of interest.

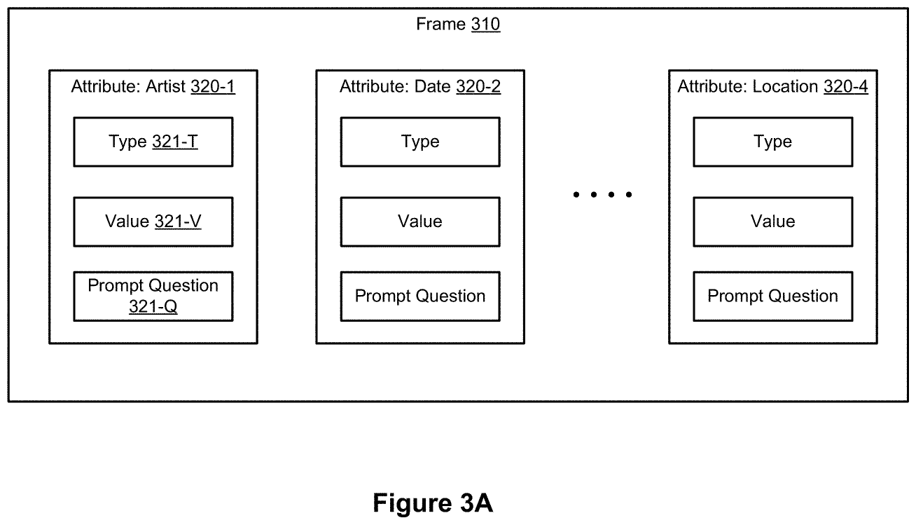

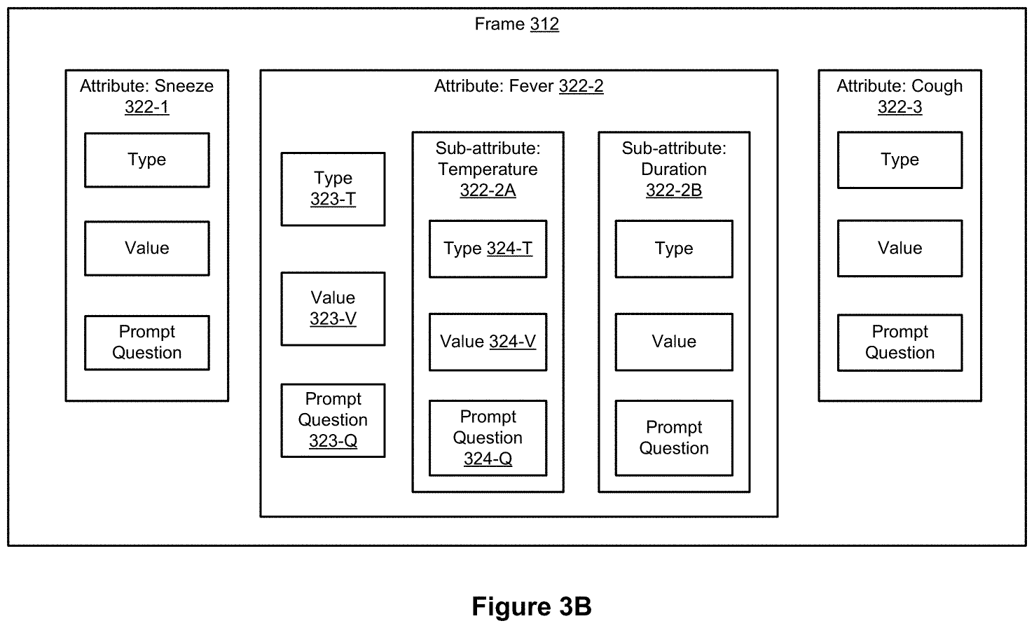

FIG. 3A is a schematic representation of a frame 310 according to some implementations. A frame is a collection of information that are relevant to a particular domain or conversational problem. For example, in a domain related to ticket purchase, the frame for such domain will include information needed to complete the purchase. Each piece of information is defined as one attribute of the frame, and each attribute has a type, value, and prompt question. As shown, each frame may contain multiple attributes, each of which can be relevant to each other, yet does not have prior relationship with each other. In a given frame, each attribute can be a separate entity within the frame, with no sequence or prior relationship with other attributes.

For example, frame 310 corresponds to a domain for purchasing concert tickets and includes a plurality of attributes, such as “artist” attribute 320-1, “date” attribute 320-2, and “location” attribute 320-4. As shown, each attribute includes a type (e.g., type 321-T), a value (e.g., value 321-V), and a prompt question (e.g., 321-Q). For example, the artist attribute may a type that is a person's name and the value as “Kelly Clarkson”. Each attribute may also include one or more prompt questions that can be used by the conversation UI to ask the user in order to fill the content for that attribute. For example, for the artist attribute, the prompt question could be “What is the name of the artist?” or “Which artist would you like to see?”

In some implementations, the value of an attribute can be Boolean (e.g., “yes” or “no”), a text string (e.g., “Las Vegas”), or numerical (e.g., “17-20”, or “137”), etc.

In some implementations, as shown in FIG. 3B, a frame may also include a composite attribute that includes one or more sub-attributes. In some cases, the sub-attribute(s) have a prior sequence relation with one another and a hierarchical structure is used. For example, frame 312 in FIG. 3B includes three attributes: “sneeze” attribute 322-1, “fever” attribute 322-2, and “cough” attribute 322-3. In this example, the attributes “sneeze” 322-1, “fever” 322-2, and “cough” 322-3 are attributes without prior relationship to one another and are attributes in the first level structured information (e.g., main attributes).

As shown in FIG. 3B, the “fever” attribute 322-2 is a composite attribute that has a main attribute, “fever”, at the first level of structured information, and two sub-attributes, “temperature” 322-2A, and “duration” 322-2B, at a second level of structured information (e.g., the “duration” 322-2B and “temperature” 322-2A sub-attributes with real number values are the second level sub-attributes within the “fever” main attribute 322-2). The main attribute, “fever,” has a type 232-T, a value 323-V, and prompt question 323-Q that corresponds to the main attribute, “fever”. For the main attribute, “fever”, the type 323-T is Boolean, the value may be “yes” or “no,” depending on an answer to the prompt question 323-Q, which may be “do you have a fever?” The sub-attributes, “temperature” 322-2A and “duration” 322-2B, each has a type, a value, and a prompt question. As shown, the sub-attribute “temperature” has a type 324-T, a value 324-V, and a prompt question 324-Q. The type 324-T is numerical, the value 324-V may include one or more values or a range of values, such as “100° F.-104° F.” or “≤101° F.,” depending on an answer to the prompt question 324-Q. When the value of the Boolean parameter for the “fever” attribute 322-2 is “yes”, more information is needed and a second level of structured information corresponding to the sub-attributes is requested. Once information regarding the value of the sub-attributes “temperature” 322-2A and “duration” 322-2B are collected, the information for the composite attribute “fever” 322-2 is complete. When the value of the Boolean parameter for the “fever” attribute 322-2 is “no”, the second level of structured information is not requested and not entered.

For each user request, a set of rules are used to determine an appropriate response that fulfills the user's request. Each rule includes a set of conditions and a response when the set of conditions are met. Each condition includes an attribute and a specified value or range of values for the attribute. Thus, the rules include attributes, which are stored in specific frames. As a result, each rule is inherently associated with a corresponding frame that stores the attributes in the rule.

In certain embodiments, the conversation may be a single task of purchasing a ticket. If the user starts the conversation with an intent of buying a particular a concert ticket, the response could be the website or phone number for purchasing the requested ticket, or a webpage with the ticket loaded in a shopping cart and fields for making a payment for the ticket. The conversation is navigated to collect information defined in the relevant rules. The condition may also include fan club membership information, with the value of “yes” or “no”. In this example, the information for each attribute can be obtained in any order, regardless of which attribute information was provided by the user first, or several attributes can be communicated at the same time since each attribute is on the same structured information level and do not have any prior relationships with one another. Usually, information for each condition in the rule needs to be obtained from the user or another source in order to trigger the response in the rule.

For example, a rule related to purchasing tickets includes a condition that requires that an “Artist” attribute has the value “Kelly Clarkson,” a “Date” condition that has the value “Dec. 20, 2020”, and a “Location” condition that has the value “Las Vegas.” An example of this rule may look like the following:

AND (artist=“Kelly Clarkson”, date=“12/20/2020”, location=“Las Vegas”)

Each conversational session ends with a response or a feedback to the user. In this example rule, after all required information has been collected, the conversational UI provides a response that includes a phone number or a link to a webpage for purchasing tickets for that particular concert.

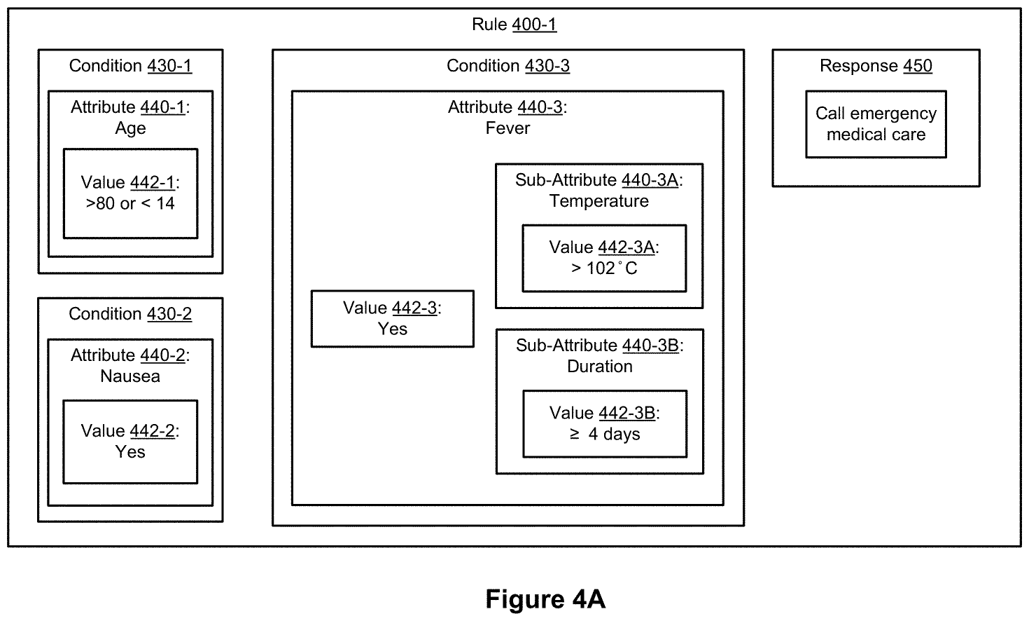

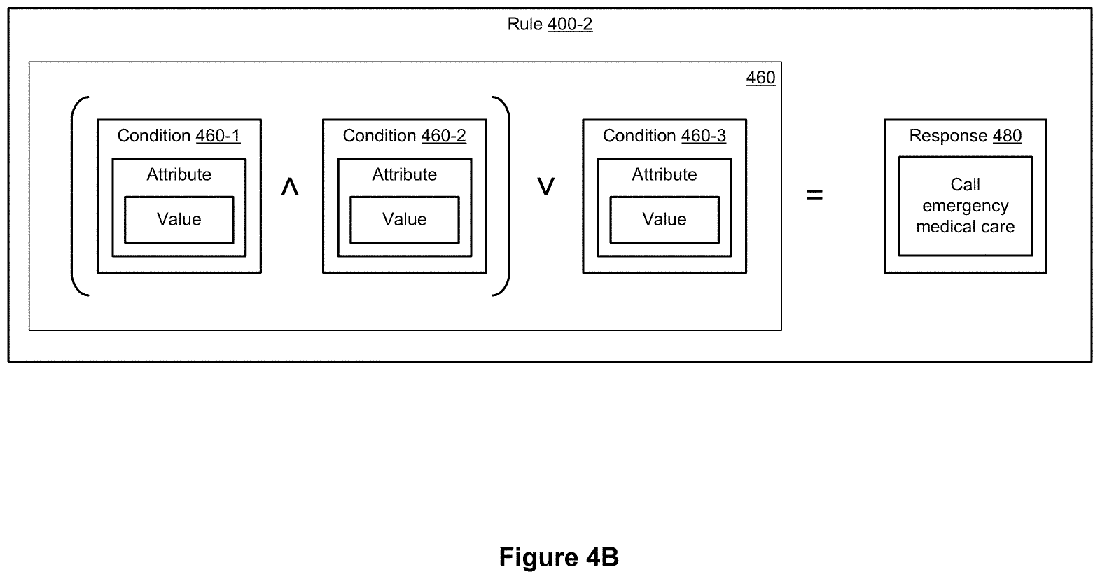

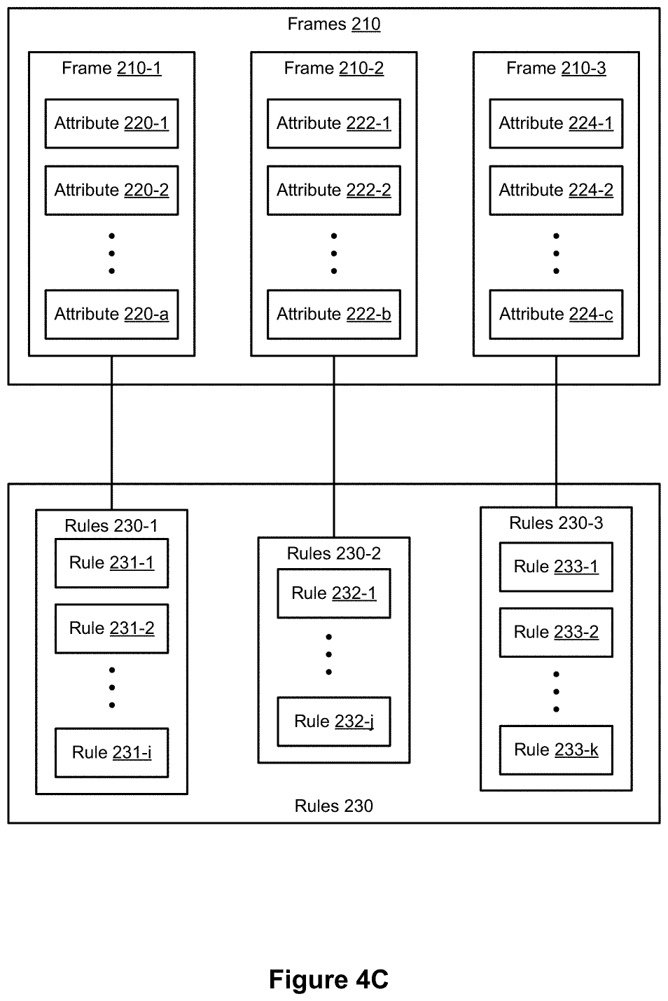

FIG. 4A is an example of a rule according to some implementations. In this example, rule 400-1 has three conditions 430-1, 430-2, and 430-3, which need to be met before response 450 is deployed by the conversation UI. In this example, condition 430-1 specifies that an “age” attribute is either “<14” or “>80 years old.” Condition 430-2 specifies that the attribute “nausea” 440-2 has a value “yes.” Condition 430-3 specifies that the attribute “fever” has a value “yes”, with the sub-attribute “body temperature” being “>102° F.”, and sub-attribute “duration” of the fever being more than 4 days. Simply, the rule looks like:

AND{[(age > 14) OR (age < 18)], nausea = “yes”, fever = “yes”,
fever_temperature > 102 ° F, fever_duration (of fever) ≥ 4 days}

In some embodiments, if the conditions in the rule are met, a defined action or response is provided to the user. If the conditions in the a rule are not met, the rule is disregarded and the user response will be selected from a different rule which has all of its conditions met. deployed. For a session related to medical diagnosis, the response is a recommendation after analyzing all the symptoms. The logic to derive such a diagnosis is defined in the rules. In the example rule, if the age is less than 14 years old, and the symptoms include nausea and a fever greater than 102° F. for 4 days or longer, then medical attention is recommended (e.g., call emergency medical care), and the action/response may include a phone number to call for medical care.

As described, a rule may include one or more composite conditions each being a combination of multiple conditions bound together using operands or logic operators, such as AND, and OR, for example. FIG. 4B shows an example of a rule 400-2 including a composite condition 460, which combines conditions 406-1, 460-2, and 463 using AND and OR operands and brackets specifying order of combinations. As shown, in order for response 480 to be deployed, composite condition 460 needs to be met, meaning that either condition 460-3 is met or both condition 460-1 and condition 460-2 are met.

FIG. 4C illustrates the relationship between frames and rules according to some implementations. As previously discussed, frames 210 include one or more frames (in this example, frames 210-1, 210-2, and 210-3), each of which include a plurality of attributes, and rules 230 include one or more rule databases (in this example, rule databases 230-1, 230-2, and 230-3), each of which includes a plurality of rules. In this example, frame 210-1 corresponds to a first topic (e.g., medical diagnosis), frame 210-2 corresponds to a second topic (e.g., ticket purchasing), and frame 210-3 corresponds to a third topic that is distinct from the first and second topics (e.g., setting appointments and reminders). Thus, the attributes in each frame will be related to the topic corresponding to each frame. For example, attributes in frame 210-1, (e.g., attributes 220-1, 220-2, . . . , 220-a) may include attributes related to medical symptoms such as “cough”, “body aches”, “bruise”, “difficulty breathing”, etc., and attributes in frame 210-2, (e.g., attributes 222-1, 222-2, . . . , 222-b) may include attributes related to ticket purchasing such as “location”, “date”, and “artist.” Each rule database 230 also corresponds to a topic (e.g., domain, subject matter). In this example, rule database 230-1 includes rules 231-1, 231-2, . . . , 231-i, which are directed to the topic of medical diagnosis. Therefore, the rules in rule database 230-1 include attributes that are stored in frame 210-1 and thus, rule database 230-1 is associated with frame 210-1. Rule database 230-2 includes rules related to the topic of ticket purchasing and thus includes attributes that are different from the rules in rule database 230-1. The rules in rule database 230-2 include attributes that are stored in frame 210-2 and thus, rule database 230-2 is associated with frame 210-2, and so forth.

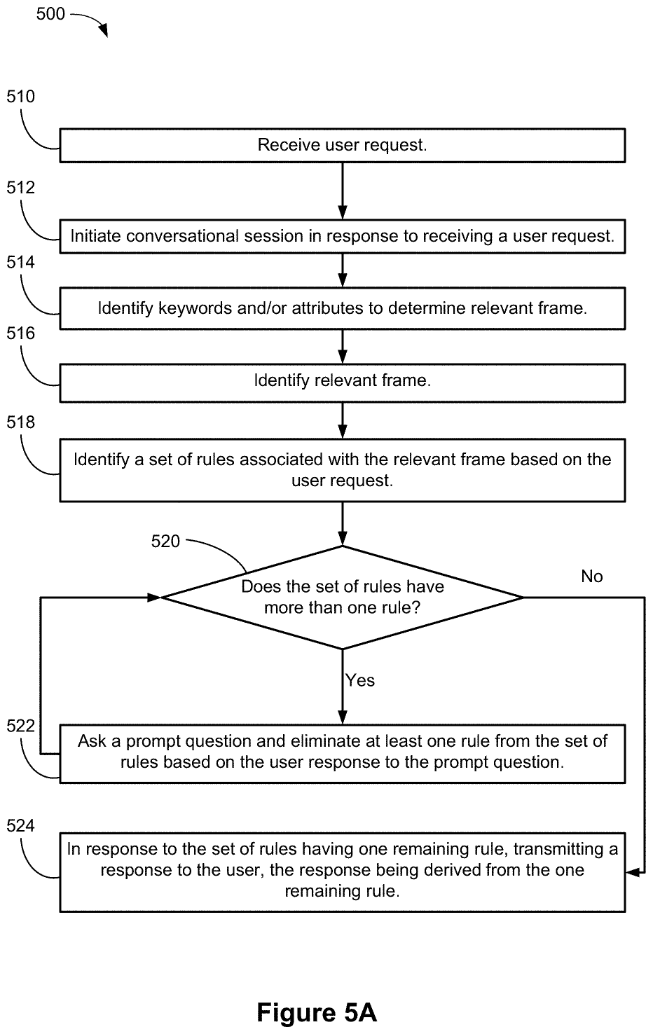

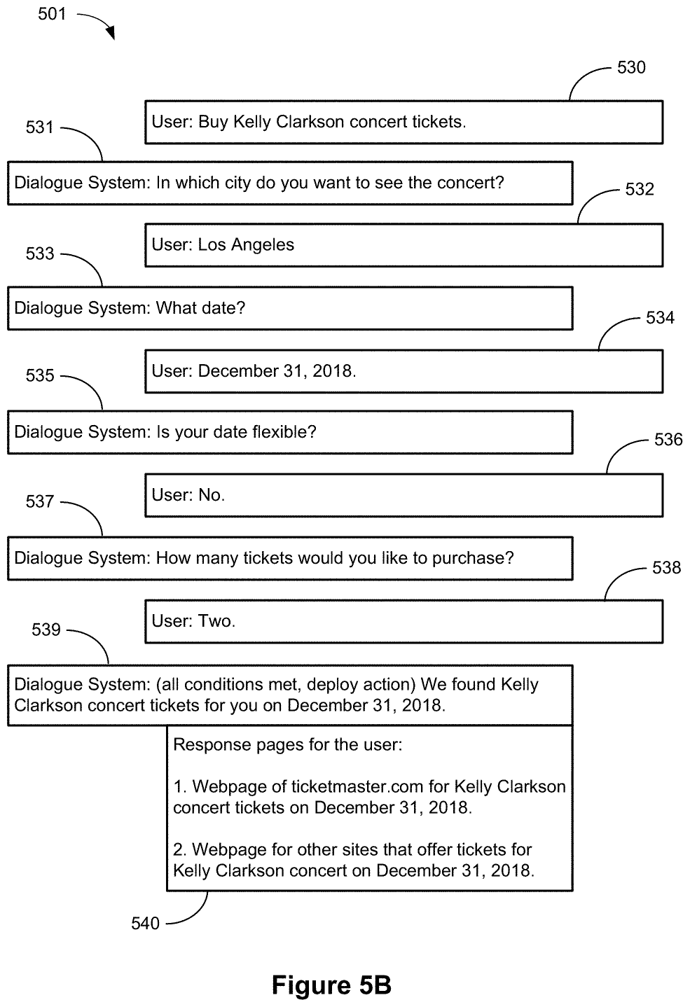

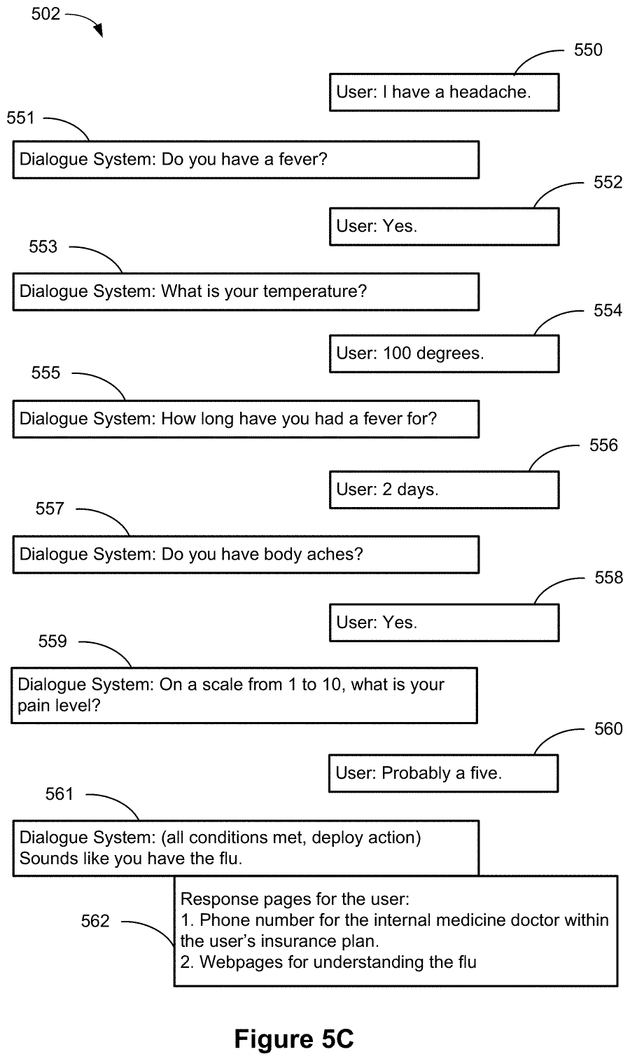

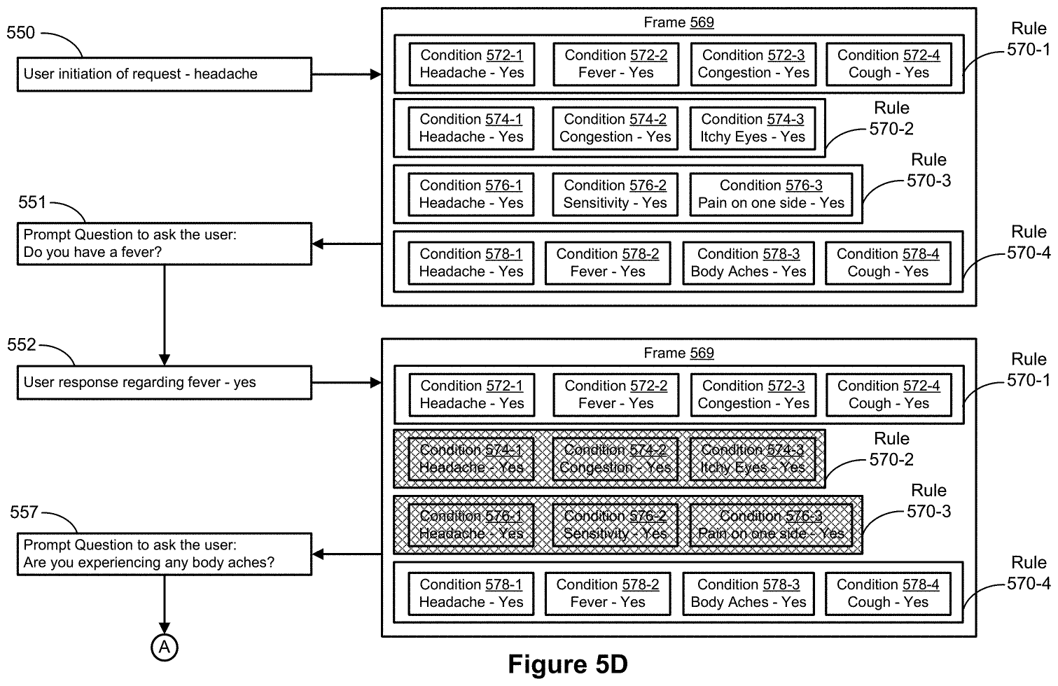

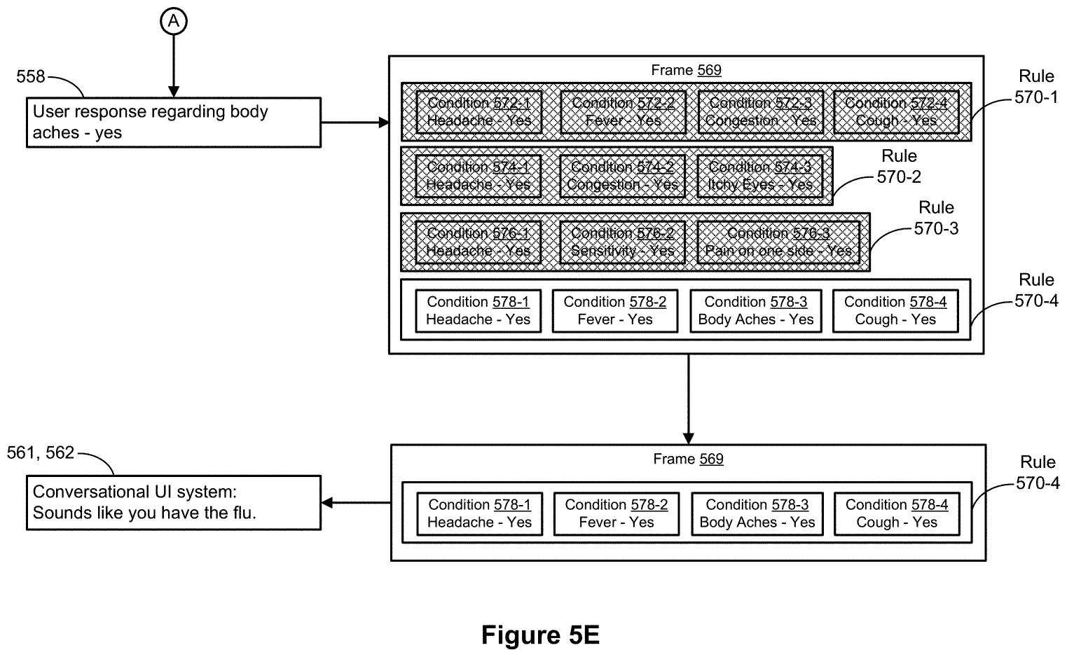

FIG. 5A illustrates a flow chart of a method of fulfilling a user request by a conversational UI system according to some implementations.

In some implementations, (steps 510 and 512) a conversational session is initiated in response to the system receiving a user request. In some implementations, the user request may only include an indication of the user's intent, such as an intention to buy ticket(s). Alternatively, the user request may also include one or more attributes or attribute values, such as name of the artist or a date range. In step 514, the conversational UI system converts (e.g., translates) the user's input into full or partial semantic frames, as described herein. Then, in step 516, the conversational UI may use one or more machine learning models to identify keywords and/or attributes in the user's request in order to determine which frames in the frame database 209 are relevant to the user's request. Once the relevant frame have been identified, the conversational UI system identifies a set of rules that are associated with the relevant frame based on the user's request in step 518. In step 520, the conversation UI determines whether or not the set of rules associated with the relevant frame includes more than one rule. In the case that the set of rules includes more than one rule, (step 522) the conversational UI asks a prompt question and, upon receiving a user response to the prompt question, eliminates at least one rule from the set of rules based on the user response. In the case that the set of rules does not include more than one rule (e.g., all rules in the set of rules have been eliminated except for one remaining rule), (step 524) the conversational UI transmits a response to the user in order to fulfill the user request. The response is derived from the one remaining rule.

For example, a user request may state “Buy tickets for a concert this weekend.” The conversational UI may extract the words “buy”, “tickets”, and “concert” as relevant keywords to use in identifying a relevant frame—in this case, a frame related to purchasing tickets. Additionally, the conversational UI may also identify the phrase “this weekend” and automatically eliminate all rules associated with the relevant frame that relate to concerts with dates that are not this weekend. If more than one rule is left in the set of rules, the conversational UI will continue to ask prompt questions in order to elicit information from the user's responses and eliminate rules in the set of rules based on the information obtained from the user's input. During this process, the UI system retrieves relevant rules from the knowledge database 124. The conditions of the rules will need to be checked to determine the most accurate response to the user. Thus, the value of attributes as provided by the user needs to be compared with the required value in the conditions in the rules. The conversational UI system solicits values of these relevant attributes if they are not yet known by asking one or more prompt questions. Once the value for an attribute is determined, the conversational UI system can proceed to eliminate (e.g., exclude) rules whose conditions require that an attribute have a value that is different from the value derived from the user's response. In some implementations, when the conversational UI system needs to obtain a value of an attribute, the value is obtained by template matching. For example, in a structured message with two parameters, <departure city> and <destination city>, the template “from <departure city> to <destination city> . . . ” is set. When the user expresses “buy airline ticket from Beijing to Shanghai”, the UI system can extract the <departure city> as “Beijing”, and <destination city> as “Shanghai” according to the template. The conversational UI system repeats this process until only one remaining rule is left. Provided that the conditions in the remaining rule are met, the conversational UI would deploy the response of the one remaining rule. For example, the conversational UI may ask the user for venues, artist, concert time, etc. until only one rule remains. If, for example, the user indicates that he/she is interested in tickets for Kelly Clarkson any time after 5 pm, any rules that include a condition that the artist attribute has a value that is another artist's name (e.g., artist=“Sam Smith”) will be eliminated. Similarly, any rules that include a condition that the concert starts at a time before 5 pm (e.g., time=3:30 pm) will also be eliminated. Once the conversation UI determines that there is only one remaining rule in the set of rules and all of the conditions of the rule are met, then the response of the rule is deployed (e.g., a link to purchase tickets for a Kelly Clarkson concert starting at 7 pm this Saturday is presented to the user, or the conversational UI loads the ticket in a shopping cart at the ticket purchase website and confirms the details of the purchase with the user before submitting payment).

FIG. 5B illustrates an example of a conversation 501 using a conversational UI system according to some implementations. In this example, the conversation 501 is a purchase dialog process. The user initiates the session by (step 530) providing a request to purchase concert tickets. The conversational UI system captures the intention of purchase and one attribute of “artist” with the value of “Kelly Clarkson” using the template matching method described herein. The conversational UI system searches within the knowledge database 124 to find rules that are related to the domain of purchasing tickets and that include the attribute of “artist” with the value “Kelly Clarkson.” In those rules, there are required parameters related to the other attributes. The conversational UI system chooses a most relevant attribute such as “location” and (step 531) asks the user to specify the location (e.g., “In which city do you want to see the concert?”) that is defined within structured information table. With the location parameter filled by the answer (e.g., Los Angeles) in step 532, the system then choose the next attribute such as “date” and (step 533) asks the user to provide a value for that attribute. The process goes on until the conversational system have values for the attributes that are required to fulfill a given rule. Once the conditions for a given rule is met and the given rule is the last remaining rule, the predefined response is deployed (step 539) to (step 540) provide the user with one or more webpages to purchase the desired tickets.

FIG. 5C illustrates another example of a conversation 502 using a conversational UI system according to some implementations. In this example, the conversation 501 is a medical recommendation (e.g., diagnostic) process. The user initiates a session with (step 550) “I have a headache”. The conversational UI system captures the user's intention of requesting a medical diagnosis and one symptom of “headache” using template matching method described herein. The conversational UI system searches within the knowledge database 124 to find rules related to “headache” (e.g, rules with an attribute “headache”). Several rules can be identified. FIGS. 5D and 5E illustrate the steps that a conversational UI system takes to navigate the conversation based on the available rules. As shown in FIG. 5D, the identified rules (e.g., rules 570-1, 570-2, 570-3, and 570-4) include the condition “headache=yes”. The conversational UI system determines that the attribute “fever” seems to be a dividing factor for the rules since half of the rules do not have fever as a symptom. The conversational UI system asks a prompt question 551 related to the attribute “fever” and receives an answer 552 from the user. Based on the user's response that he/she has a fever, rules 570-2 and 570-3 are eliminated since they do not include a condition that “fever=yes.” In this example, the conversation UI system could have also asked the user a prompt question about congestion since the attribute “congestion” is also included in only half of the identified rules. In some implementations, as shown, the conversation UI system is configured to identify attribute(s) whose values have not been provided by the user that will allow the conversation UI system to eliminate the maximum number of rules possible regardless of the user's answer. For example, regardless of whether the user answers “yes” or “no” to the prompt question regarding fever (or congestion), the conversational UI system will be able to eliminate at least half the rules.

Referring to FIG. 5C, since the user indicated that he/she has a fever, the conversational UI system asks the user for input for values regarding the sub-attributes for the fever attribute. As shown, the conversational UI system asks the user, in steps 533 and 555, respectively, what the user's temperature is and how long the user has had the fever for. Once values all the sub-attributes for the main attribute (in this example, “fever”) have been collected from user responses, the conversational UI system asks another prompt question (step 557) corresponding to another attribute.

Referring to FIG. 5E, based on the user's response 558 that the user is experiencing body aches, the conversational UI system selects rule 570-4 over rule 570-1. After eliminating rule 570-1, rule 570-4 is the one remaining rule. Since all the conditions in rule 570-4 have been met, the conversational UI system deploys a response 561 based on rule 570-4, “Sounds like you have the flu.” The conversational UI system may also include resources 562, such as links or phone numbers, that may be useful to the user based on the response.

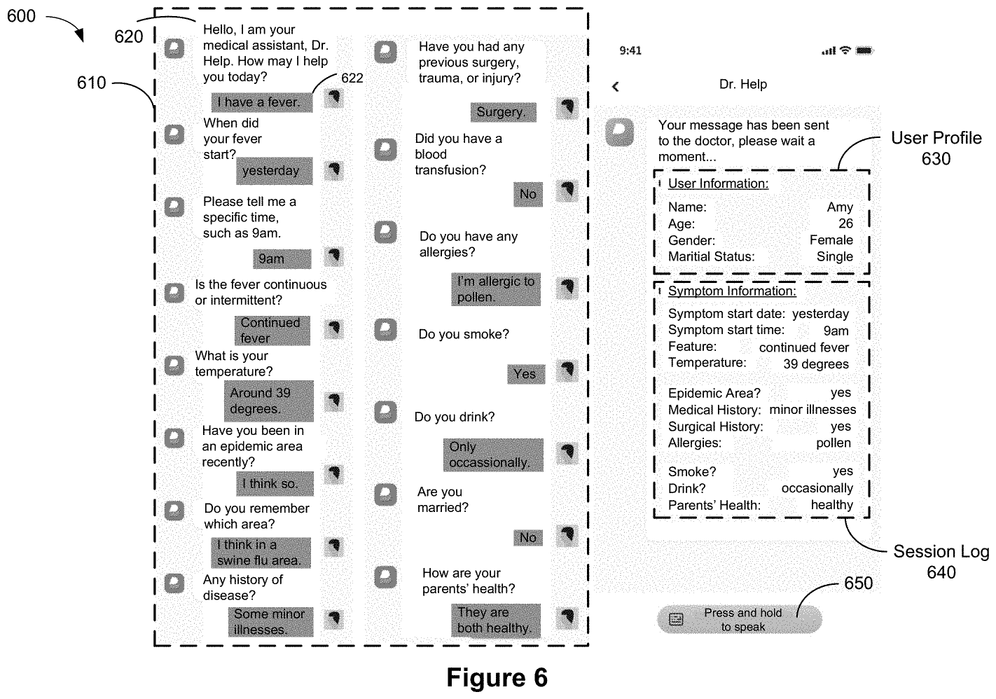

FIG. 6 illustrates an example of a user interface 600 of a rule-based conversational UI system (e.g., rule-based conversational UI system 200) according to some implementations. In this example, a dialogue interface 610 includes messages 620 from the conversational UI system as well as messages 622 from the user. Messages 620 from the conversational UI system may include a greeting, prompt questions, clarification or confirmation questions (e.g., “can you please repeat that?” or “are you sure you want to purchase the tickets?”). Messages 622 from the user may include user requests, answers to prompt questions, as well as user commands (e.g., “log out” or “start a new session”). The messages 620 and 622 in dialogue interface 610 provide another example of a conversation using the conversational UI system. As shown, a user profile 630 and a session log 640 may be created to store information regarding the user and may be shown on the user interface 600. Session log 640 may be created based on the interactions on the user interface 600 and stores information regarding a specific session associated with the user profile 630. In some implementations, the session log 640 is stored for a predetermined period of time (e.g., 1 hour after end of session, 1 day after session initiation, 1 year after end of session, etc) and deleted from the conversational UI system once the predetermined period of time has passed. In some implementations, the predetermined period of time may be based on user activity. For example, a session log 640 may be deleted after a user profile 630 is determined to be inactive for more than 1 year. In some implementations, user interface is a text-based interface and dialogue interface 610 displays the typed text input by the user via a user device (e.g., a smart phone, tablet, or computer). In some implementations, the conversational UI system can receive voice commands and the user interface 600 displays information regarding the session. In such cases, user interface may optionally include a user affordance 650 that enables user input (e.g., “press and hold to speak”). In such cases, the dialogue interface 610 displays text transcribed based on the user's voice input via a user device.

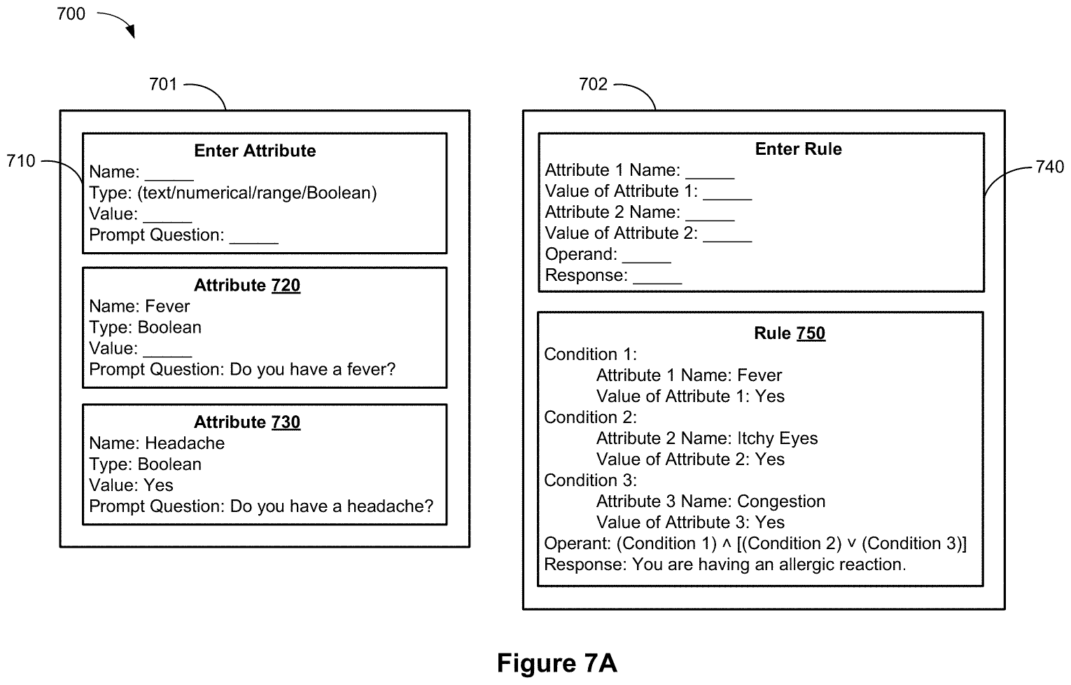

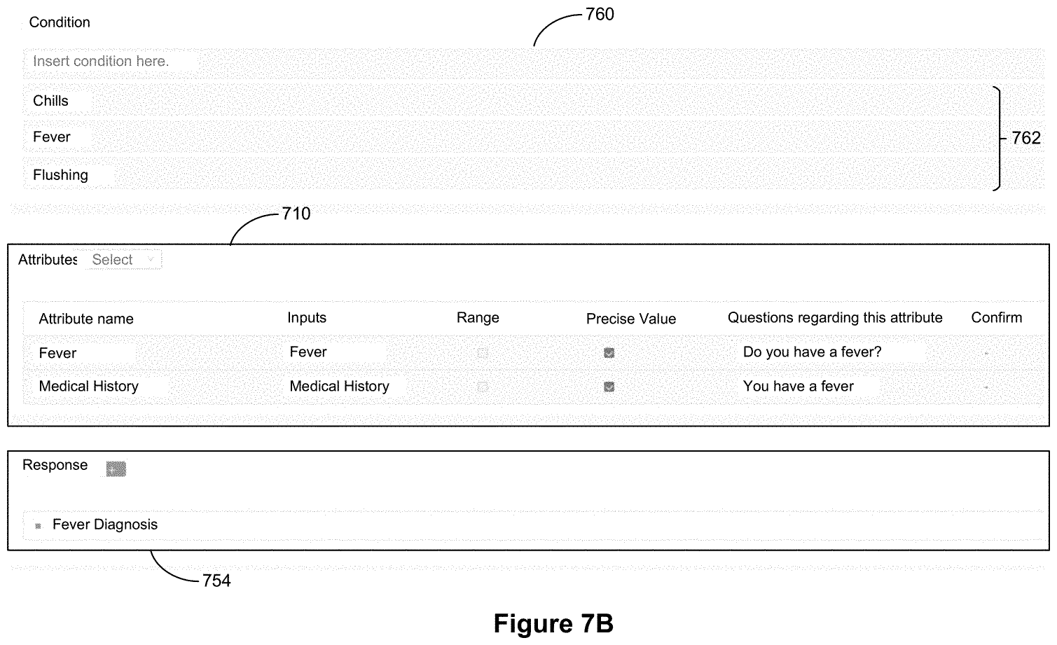

FIG. 7A is a schematic representation of an expert user input interface 700 according to some implementations. As shown, an expert user input interface 700 includes an attribute interface 701 and a rule interface 702. In some implementations, the expert user input interface 700 may auto populate fields in the attribute interface 701 based on user input received in fields of the rule interface 702 or vice versa.

Attribute interface 701 includes an attribute input interface 710 that includes one or more fields (e.g., “name”, “type”, “value”, “prompt question”) for entering information regarding an attribute. In some implementations, as shown, attribute interface 701 also displays attributes that have been previously entered by an expert user (e.g., attributes 720 and 730). In some implementations, the “value” of an attribute in the attribute interface 701 is a placeholder (see attribute 720). In some implementations, the “value” of an attribute in the attribute interface 701 includes a base value or default value that is defined by an expert user (see attribute 730).

Rule interface 702 includes a rule input interface 740 that includes one or more fields (e.g., “attribute name”, “attribute type”, “attribute value”, “operand”, and “response”) for entering information regarding an rule. In the rule input interface 740, an expert user can define conditions (e.g., attributes and values) as well as define operands for combining conditions (e.g., [condition 1 OR condition 2] AND [condition 3]) to form composite conditions. The rule input interface 740 also includes one or more field(s) 754 for receiving information regarding a response associated with a specified rule. In some implementations, as shown, rule interface 702 also displays rules that have been previously entered by an expert user (e.g., rule 750). An example of an expert user input interface is shown in FIG. 7B. As shown, attributes and values for conditions in rules can be entered in fields 760 (which corresponds to rule input interface 740), and fields 762 display attributes that have been previously entered by the expert user. As shown, attribute input interface 710 displays attributes in the rule as well as characteristics (e.g., type, prompt question) for each attribute. In this example, a field 754 displays that the response for the rule is a fever diagnosis.

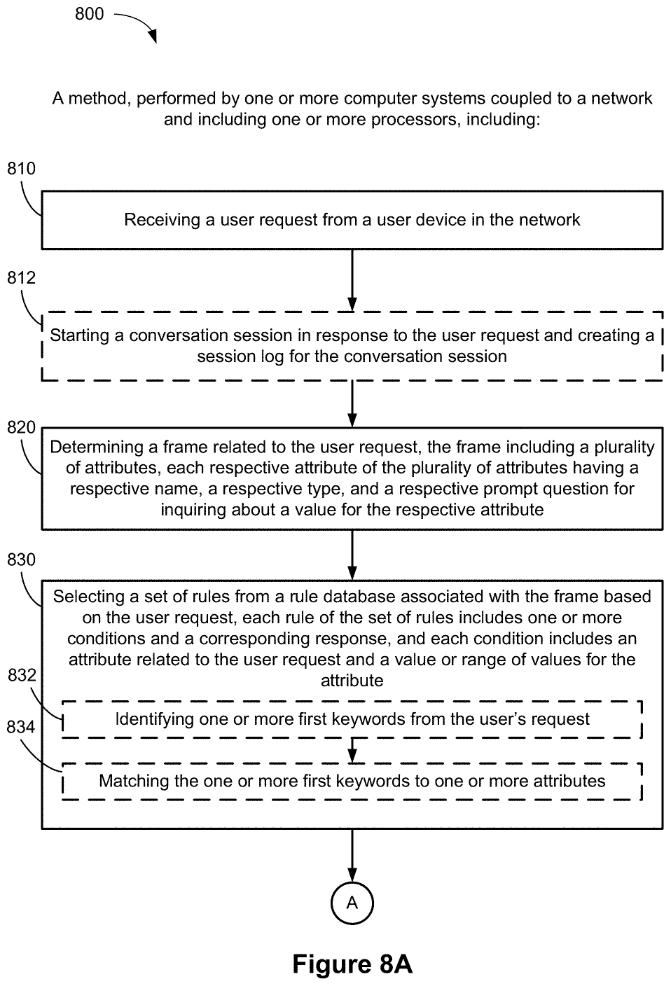

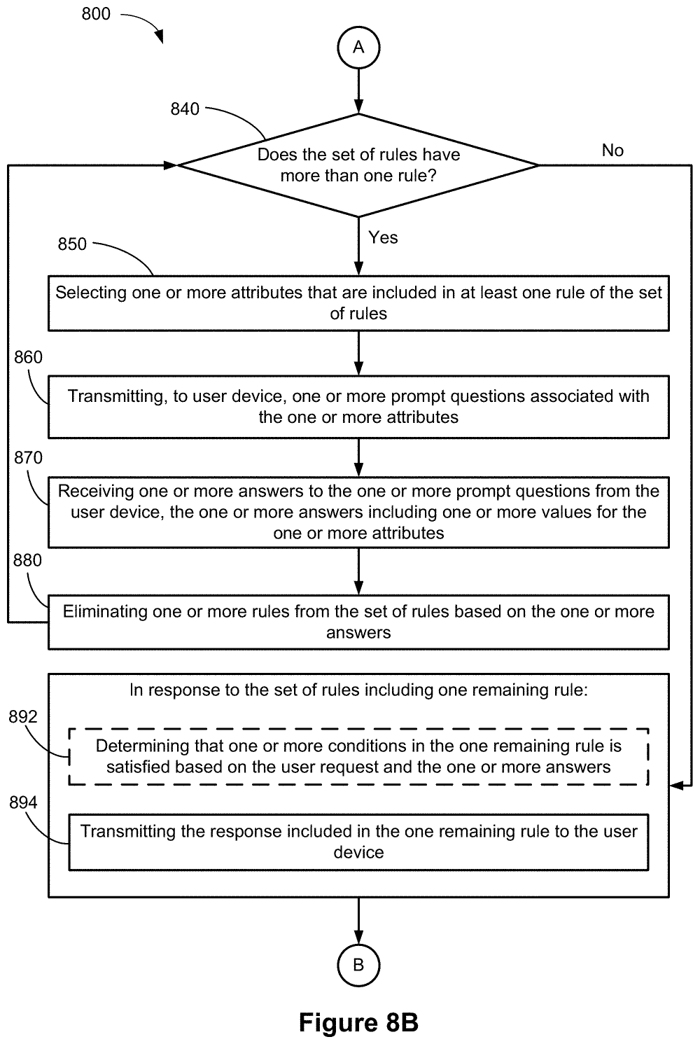

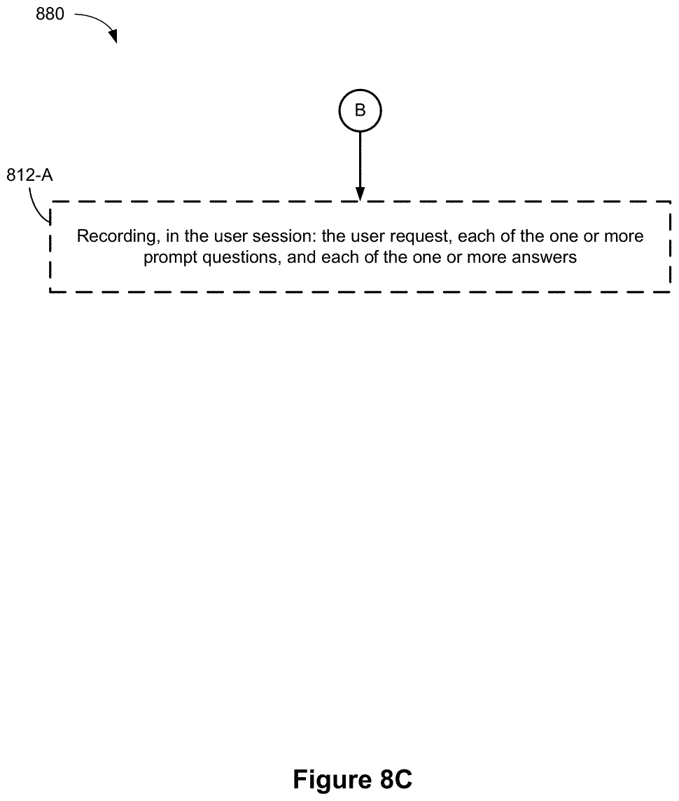

FIGS. 8A-8C is a flow chart illustrating a method 800 in a rule-based conversational UI system (e.g., system 200) to receive and fulfill user request according to some implementations. The method 800 is performed by one or more computer systems coupled to a network and including one or more processors. The method 800 includes (step 810) receiving a user request from a user device in the network. The method 800 also includes (step 820) determining a frame related to the user request. The frame includes a plurality of attributes and each respective attribute of the plurality of attributes has a respective name, a respective type, and a respective prompt question for inquiring about a value for the respective attribute. The method also includes (step 830) selecting a set of rules from a rule database associated with the frame based on the user request. Each rule of the set of rules includes one or more conditions and a corresponding response, and each condition includes an attribute related to the user request and a value or range of values for the attribute. In response to the set of rules including more than one rule (step 840, yes), the method includes (step 850) selecting one or more attributes that are included in at least one rule of the set of rules; (step 860) transmitting, to the user device, one or more prompt questions associated with the one or more attributes; (step 870) receiving one or more answers to the one or more prompt questions from the user device; and (step 880) eliminating one or more rules from the set of rules based on the one or more answers. The one or more answers includes one or more values for the one or more attributes. In response to all other rules except one remaining rule having been eliminated from the set of rules (step 840, no), the method 800 includes (step 894) transmitting the response included in the one remaining rule to the user device. In some implementations, the method 800 includes (step 892) determining that the one or more conditions in the one remaining rule is satisfied based on the user request and the one or more answers before transmitting the response included in the one remaining rule to the user device.

In some implementations, (step 830) selecting a set of rules from a rule database associated with the frame based on the request includes (step 832) identifying one or more first keywords from the user's request, and (step 834) matching the one or more first keywords to one or more attributes.

In some implementations, the method includes, prior to receiving a user request, receiving one or more first training sentences and matching the one or more first keywords includes matching the one or more first keywords to at least a portion of a first example sentence. The one or more first training sentences include an example sentence and a corresponding domain of interest or frame identifier and the identified set of rules corresponds to the same domain as the first example sentence.

In some implementations, the method includes, in response to receiving one or more answers to the one or more prompt questions from the user device, determining the one or more values for the one or more attributes by extracting one or more second keywords that are associated with an attribute of the one or more attributes, and extracting one or more third keywords that are associated with possible values of the attribute.

In some implementations, eliminating the one or more rules includes eliminating a rule that does not include any of the one or more attributes.

In some implementations, the one or more values include a first value for a first attribute, and eliminating the one or more rules includes eliminating a rule that has a condition that has the first attribute and a value for the first attribute that is different from the first value.

In some implementations, the method 800 further includes (step 812), in response to the user input, starting a conversation session and creating a session log for the conversation session. In some embodiment, a user profile is created or preexisting (if the user has had previous conversations with the rule-based conversational UI system 200), and the session log is associated with the user profile. In some embodiments, the user request, and subsequent prompt questions, and answers are recorded in the session log. In some implementations, the one or more second attributes are selected based at least on recorded data in the session log after receiving the one or more answers. In some implementations, the session log is stored for a predetermined duration.

In some implementations, the one or more conditions include a composite condition formed using one or more operands that logically combine a plurality of conditions.

In some implementations, the method includes, prior to receiving a user request, receiving one or more second training sentences and comparing the one or more answers to the one or more second training sentences. The one or more second training sentences include a prompt question corresponding to an attribute, a second example sentence, and an indicator. The method also includes selecting a sentence of the one or more second training sentences that is most similar to the one or more answers and recording a value corresponding to the attribute based on at least an indicator corresponding to the selected sentence.

In some implementations, at least one of the set of rules includes a composite attribute. The composite attribute includes a primary attribute and one or more secondary attributes that are dependent on the primary attribute.

In some implementations, the one or more attributes include a first attribute and a second attribute, and the one or more prompt questions include one or more first prompt questions that are associated with the first attribute and one or more second prompt questions that are associated with the second attribute. The one or more answers include one or more first answers to the one or more first prompt questions and one or more second answers to one or more second prompt questions. Eliminating one or more rules includes eliminating one or more first rules after receiving the one or more first answers and before receiving the one or more second answers as well as eliminating one or more second rules after receiving the one or more second answers. The one or more second attributes are selected after eliminating the one or more first rules and before eliminating the one or more second ruled. The one or more second prompt questions are transmitted after the one or more second attributes are selected.

In some implementations, the one remaining rule includes a first number of attributes, the one or more prompt questions include a second number of prompt questions, and the second number is at least one less than the first number.

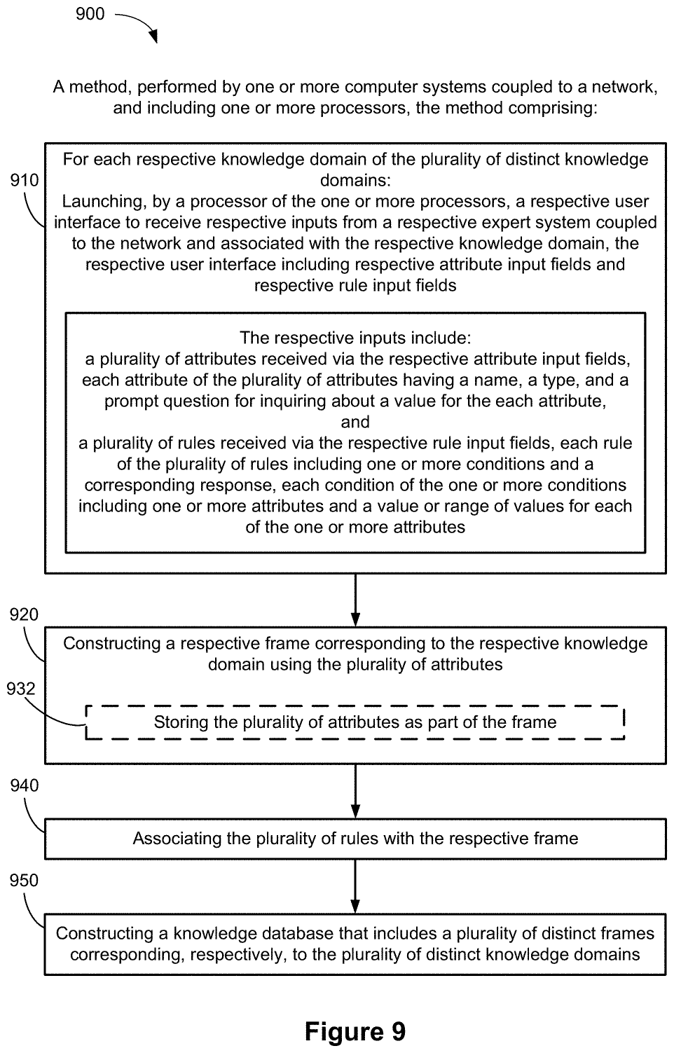

FIG. 9 is a flow chart illustrating a method 900 in a rule-based conversational UI system (e.g., system 200) to construct knowledge databases according to some implementations. The knowledge databases correspond to a plurality of expert systems that are coupled to a network and associated with a plurality of distinct knowledge domains. The method 900 is performed by one or more computer systems (e.g., computer system 121) that are coupled to a network (e.g., network 130) and the one or more computer systems include one or more processors (e.g., CPU(s) 171). The method 900 includes, for each respective knowledge domain of the plurality of distinct knowledge domains (step 910) launching, by a processor of the one or more processors, at least one respective user interface to receive respective inputs from a respective expert system associated with the respective knowledge domain. The at least one respective user interface includes respective attribute input fields and respective rule input fields. The respective inputs include a plurality of attributes that are received via the respective attribute input fields. Each attribute of the plurality of attributes has a name, a type, and a prompt question for inquiring about a value for the each attribute. The respective inputs also include a plurality of rules that are received via the respective rule input fields. Each rule of the plurality of rules includes one or more conditions and a corresponding response. Each condition of the one or more conditions includes one or more attributes and a value or range of values for each of the one or more attributes. The method 900 further includes (step 920) constructing a respective frame corresponding to the respective knowledge domain using the plurality of attributes, and (step 940) associating the plurality of rules with the respective frame.

In some implementations, the method 900 further includes (step 950) constructing a knowledge database that includes a plurality of distinct frames corresponding, respectively, to the plurality of distinct knowledge domains.

In some implementations, (step 920) constructing a respective frame corresponding to the respective knowledge domain using the plurality of attributes includes (step 932) storing the plurality of attributes as part of the frame.

In some implementations, the plurality of distinct knowledge domains include a plurality of distinct conversation topics.

In some implementations, the plurality of distinct knowledge domains include a plurality of distinct categories of tasks.

In some implementations, the one or more conditions include a composite condition formed by combining multiple conditions with one or more operands.

In some implementations, the plurality of attributes are stored in a respective attributes database as the respective frame. In some implementations, the plurality of rules are stored in a respective rule database associated with the respective frame.

In accordance with some implementations a method performed by one or more computer systems that are coupled to a network and include one or more processors includes receiving, by a processor of the one or more processors, a user request from a user device in the network. The method also includes determining a frame related to the user request. The frame includes a plurality of attribute. Each respective attribute of the plurality of attributes have a respective name, a respective type, and a respective prompt question for inquiring about a value for the respective attribute. The method further includes selecting a set of rules from a rule database associated with the frame based on the request. Each rule of the set of rules includes one or more conditions and a corresponding response, and each condition includes an attribute related to the user request and a value or range of values for the attribute. In response to the set of rules including more than one rule the method includes selecting one or more attributes that are included in at least one rule of the set of rules; transmitting, to the user device, one or more prompt questions associated with the one or more attributes; receiving one or more answers to the one or more prompt questions from the user device, the one or more answers including one or more values for the one or more attributes; and eliminating one or more rules from the set of rules based on the one or more answers. In response to all other rules except one remaining rule having been eliminated from the set of rules, the method includes transmitting the response included in the one remaining rule to the user device.

In some implementations, eliminating the one or more rules includes eliminating a rule that does not include any of the one or more attributes.

In some implementations, the one or more values include a first value for a first attribute, and eliminating the one or more rules includes eliminating a rule having a condition that has the first attribute and a value for the first attribute that is different from the first value.

In some implementations, the method further comprises determining that the one or more conditions in the one remaining rule is satisfied based on the user request and the one or more answers before transmitting the response included in the one remaining rule to the user device.

In some implementations, the user request and the one or more answers are recorded in a user session that is associated with a user profile and stored for a predetermined duration.

In some implementations, at least a first rule in the set of rules includes one or more operands that logically combine the one or more conditions included in the first rule to form the first rule.

In some implementations, at least one of the set of rules includes a composite attribute. The composite attribute includes a primary attribute and one or more secondary attributes that are dependent on the primary attribute.

In some implementations, the one or more attributes include a first attribute and a second attribute, the one or more prompt questions include one or more first prompt questions associated with the first attribute and one or more second prompt questions associated with the second attribute, and the one or more answers include one or more first answers to the one or more first prompt questions and one or more second answers to one or more second prompt questions. In some implementations, eliminating one or more rules includes eliminating one or more first rules after receiving the one or more first answers and before receiving the one or more second answers and eliminating one or more second rules after receiving the one or more second answers. In some implementations, the one or more second attributes are selected after eliminating the one or more first rules and before eliminating the one or more second rules, and the one or more second prompt questions are transmitted after the one or more second attributes are selected.

In some implementations, the method further includes providing a user session in response to the user request and recording, in the user session the user request, each of the one or more prompt questions, and each of the one or more answers. The one or more second attributes are selected based at least on recorded data in the user session after receiving the one or more first answers.

In some implementations, the one remaining rule includes a first number of attributes, the one or more prompt questions include a second number of prompt questions, and the second number is at least one less than the first number.

In some implementations, selecting a set of rules from a rule database associated with the frame includes identifying one or more first keywords from the user's request and matching the one or more first keywords to one or more attributes.

In some implementations, the user request is a voice command, and determining a frame related to the user request includes transcribing the voice command into text such that the text can be used to identify the one or more first keywords

In some implementations, the method further includes, prior to receiving a user request, receiving one or more first training sentences. The one or more first training sentences include an example sentence and a corresponding domain of interest or frame identifier. Additionally, matching the one or more first keywords includes matching the one or more first keywords to at least a portion of a first example sentence. The identified set of rules corresponds to the same domain as the first example sentence.

In some implementations, the method further includes, in response to receiving one or more answers to the one or more prompt questions from the user device, determining the one or more values for the one or more attributes. Determining the one or more values for the one or more attributes includes extracting one or more second keywords that are associated with an attribute of the one or more attributes, and extracting one or more third keywords that are associated with possible values of the attribute.

In some implementations, the method further includes, prior to receiving a user request, receiving one or more second training sentences that include a prompt question corresponding to an attribute, a second example sentence, and an indicator. The method also includes comparing the one or more answers to the one or more second training sentences, selecting a sentence of the one or more second training sentences that is most similar to the one or more answers, and recording a value corresponding to the attribute based on at least an indicator corresponding to the selected sentence.

In accordance with some implementations, a method to generate knowledge databases corresponding to a plurality of expert systems coupled to a network and associated with a plurality of distinct knowledge domains is performed by one or more computer systems coupled to a network. The one or more computer systems include one or more processors. The method includes, for each respective knowledge domain of the plurality of distinct knowledge domains launching, by a processor of the one or more processors, at least one respective user interface to receive respective inputs from a respective expert system associated with the respective knowledge domain. The at least one respective user interface includes respective attribute input fields and respective rule input fields. The respective inputs include a plurality of attributes that are received via the respective attribute input fields. Each attribute of the plurality of attributes has a name, a type, and a prompt question for inquiring about a value for the each attribute. The respective inputs also include a plurality of rules received via the respective rule input fields. Each rule of the plurality of rules includes one or more conditions and a corresponding response. Each condition of the one or more conditions includes one or more attributes and a value or range of values for each of the one or more attributes. The method further includes forming a respective frame corresponding to the respective knowledge domain using the plurality of attributes and associating the plurality of rules with the respective frame.

In some implementations, the method also includes storing the plurality of attributes in a respective attributes database as the respective frame. In some implementations, the method also includes storing the plurality of rules in a respective rule database associated with the respective frame.

In some implementations, constructing a knowledge database includes a plurality of distinct frames corresponding, respectively, to the plurality of distinct knowledge domains.

In some implementations, the plurality of distinct knowledge domains include a plurality of distinct conversation topics.

In some implementations, the plurality of distinct knowledge domains include a plurality of distinct categories of tasks.

In some implementations, the one or more conditions include a composite condition formed by combining multiple conditions with one or more operands.

In some implementations, constructing a respective frame corresponding to the respective knowledge domain using the plurality of attributes includes storing the plurality of attributes as part of the respective frame.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method performed by one or more computer systems coupled to a network and including one or more processors, comprising:
receiving a user request from a user device in the network;
determining a frame related to the user request, the frame including a plurality of attributes, each respective attribute of the plurality of attributes having a respective name, a respective type, and a respective prompt question for inquiring about a value for the respective attribute;
selecting a set of rules from a rule database associated with the frame based on the user request, wherein:
each rule of the set of rules includes one or more conditions and a corresponding response; and
each condition includes an attribute related to the user request and a value or range of values for the attribute;
in response to the set of rules including more than one rule:
selecting one or more attributes that are included in at least one rule of the set of rules;
transmitting, to the user device, one or more prompt questions associated with the one or more attributes;
receiving one or more answers to the one or more prompt questions from the user device, the one or more answers including one or more values for the one or more attributes; and
eliminating one or more rules from the set of rules based on the one or more answers; and
in response to all other rules except one remaining rule having been eliminated from the set of rules:
transmitting the response included in the one remaining rule to the user device.

2. The method of claim 1, wherein eliminating the one or more rules includes eliminating a rule that does not include any of the one or more attributes.

3. The method of claim 1, wherein the one or more values include a first value for a first attribute, and wherein eliminating the one or more rules includes eliminating a rule having a condition that has the first attribute and a value for the first attribute that is different from the first value.

4. The method of claim 1, further comprising determining that the one or more conditions in the one remaining rule is satisfied based on the user request and the one or more answers before transmitting the response included in the one remaining rule to the user device.

5. The method of claim 1, wherein the user request and the one or more answers are recorded in a user session that is associated with a user profile and stored for a predetermined duration.

6. The method of claim 1, wherein at least a first rule in the set of rules includes a composite condition formed using one or more operands that logically combine a plurality of conditions.

7. The method of claim 1, wherein at least one of the set of rules includes a composite attribute, the composite attribute including a primary attribute and one or more secondary attributes dependent on the primary attribute.

8. The method of claim 1, wherein:
the one or more attributes include a first attribute and a second attribute;
the one or more prompt questions include one or more first prompt questions associated with the first attribute and one or more second prompt questions associated with the second attribute;
the one or more answers include one or more first answers to the one or more first prompt questions and one or more second answers to one or more second prompt questions;
eliminating one or more rules include eliminating one or more first rules after receiving the one or more first answers and before receiving the one or more second answers, and eliminating one or more second rules after receiving the one or more second answers;
one or more second attributes are selected after eliminating the one or more first rules and before eliminating the one or more second rules; and
the one or more second prompt questions are transmitted after the one or more second attributes are selected.

9. The method of claim 8, further comprising:
providing a user session in response to the user request; and
recording, in the user session the user request, each of the one or more prompt questions, and each of the one or more answers, wherein
the one or more second attributes are selected based at least on recorded data in the user session after receiving the one or more first answers.

10. The method of claim 1, wherein:
the one remaining rule includes a first number of attributes;
the one or more prompt questions include a second number of prompt questions; and
the second number is at least one less than the first number.

11. The method of claim 1, wherein selecting a set of rules from a rule database associated with the frame includes:
identifying one or more first keywords from the user's request; and
matching the one or more first keywords to one or more attributes.

12. The method of claim 11, further comprising:
prior to receiving a user request, receiving one or more first training sentences, wherein the one or more first training sentences include an example sentence and a corresponding domain of interest or frame identifier; and
matching the one or more first keywords includes matching the one or more first keywords to at least a portion of a first example sentence, wherein the set of rules corresponds to the same domain as the first example sentence.

13. The method of claim 1, further comprising:
in response to receiving one or more answers to the one or more prompt questions from the user device, determining the one or more values for the one or more attributes by:
extracting one or more second keywords that are associated with an attribute of the one or more attributes; and
extracting one or more third keywords that are associated with possible values of the attribute.

14. The method of claim 13, further comprising:
prior to receiving a user request, receiving one or more second training sentences, wherein the one or more second training sentences include a prompt question corresponding to an attribute, a second example sentence, and an indicator; and
comparing the one or more answers to the one or more second training sentences;
selecting a sentence of the one or more second training sentences that is most similar to the one or more answers; and
recording a value corresponding to the attribute based on at least an indicator corresponding to the selected sentence.

15. A method, performed by one or more computer systems coupled to a network and including one or more processors, the method comprising:
for each respective knowledge domain of a plurality of distinct knowledge domains:
launching, by a processor of the one or more processors, a respective user interface to receive respective inputs from a respective expert system coupled to the network and associated with the respective knowledge domain, the respective user interface including respective attribute input fields and respective rule input fields;
the respective inputs including:
a plurality of attributes received via the respective attribute input fields, each attribute of the plurality of attributes having a name, a type, and a prompt question for inquiring about a value for the each attribute; and
a plurality of rules received via the respective rule input fields, each rule of the plurality of rules including one or more conditions and a corresponding response when the one or more conditions are satisfied, each condition of the one or more conditions including one or more attributes and a value or range of values for each of the one or more attributes;
constructing a respective frame corresponding to the respective knowledge domain using the plurality of attributes; and
associating the plurality of rules with the respective frame.

16. The method of claim 15, further comprising constructing a knowledge database that includes a plurality of distinct frames corresponding, respectively, to the plurality of distinct knowledge domains.

17. The method of claim 16, wherein the plurality of distinct knowledge domains include a plurality of distinct conversation topics.

18. The method of claim 16, wherein the plurality of distinct knowledge domains include a plurality of distinct categories of tasks.

19. The method of claim 15, wherein the one or more conditions include a composite condition formed by combining multiple conditions with one or more operands.

20. The method of claim 15, wherein constructing a respective frame corresponding to the respective knowledge domain using the plurality of attributes comprises storing the plurality of attributes as part of the respective frame.
